(19) United States
(12) Patent Application Publication
(10) Pub. No.: US 2012/0006816 A1
(43) Pub. Date: Jan. 12, 2012

(54) COLLAPSIBLE CONTAINER AND METHOD FOR ERECTING CONTAINER

(76) Inventor: T. Cody Turnquist, Hamel, MN (US)

(21) Appl. No.: 13/144,611

(22) PCT Filed: Jan. 26, 2010
(86) PCT No.: PCT/US10/22063

§ 371 Date: Sep. 23, 2011

Related U.S. Application Data
(60) Provisional application No. 61/185,017, filed on Jun. 8, 2009.

(51) Int. Cl. B65D 6/26; E05B 65/06; E06B 3/34

(52) U.S. Cl. 220/4.33; 49/394

(57) ABSTRACT

Technology related to collapsible shipping containers is described herein. For example, a lifting mechanism is described having a first lift beam and a second lift beam, where the lift beam is pivotably attached to the container at one end and slidably attached to the container at another end. In addition, tensioning systems, locking systems, cable systems and arrangements for folding axes are described herein in the context of a collapsible shipping container.

This application is being filed as a PCT International Patent application on Jan. 26, 2010, in the name of T Cody Turnquist, a U.S. Citizen, and claims priority to U.S. patent application Ser. No. 61/147,322, titled “Collapsible Container and Method for Erecting Container,” filed Jan. 26, 2009 and U.S. patent application Ser. No. 61/185,017, titled “Collapsible Container and Method for Erecting Container,” filed Jun. 8, 2009; the contents of which are herein incorporated by reference.

### FIELD OF THE INVENTION

The technology disclosed herein relates to shipping containers. More particularly, the technology disclosed herein relates to a collapsible shipping container.

### SUMMARY OF THE INVENTION

An embodiment of a collapsible container is described herein including a container top substantially defining a top plane and a first longitudinal side coupled to the container top adjacent to a top edge of the first longitudinal side. The first longitudinal side has a first intermediate folding axis substantially parallel to the top plane, a first bottom folding axis substantially parallel to the top plane, and a first top folding axis substantially parallel to the top plane, where the first top folding axis is a first distance from the top plane. The container also includes a second longitudinal side coupled to the container top, adjacent to a top edge of the second longitudinal side. The second longitudinal side has a second intermediate folding axis substantially parallel to the top plane, a second top folding axis substantially parallel to the top plane, where the second top folding axis is a second distance from the top plane where the second distance is greater than the first distance, and a second bottom folding axis substantially parallel to the top plane. The container further includes a container bottom coupled to the first longitudinal side and the second longitudinal side.

Embodiments of a shipping container with a tensioning mechanism are described herein including a shipping container having a sidewall and an edge, where the sidewall defines passages through which cable can pass, and a plurality of tension cables running through the passages in a plane substantially parallel to a plane defined by a surface of the sidewall, where each cable of the plurality of tension cables has a first end coupled proximate to the edge of the container and a second end. The system further includes a spindle system connected to the second ends of the tension cables and configured to collect the one or more tension cables when the container is expanded and release one or more tension cables from the second ends when the container is collapsed.

In another embodiment, a tensioning mechanism for a shipping container is described comprising a first cable having a first end and second end, where the first end of the first cable is fixed adjacent to a first edge of a wall, a second cable having a first end and second end, where the first end of the second cable is fixed proximate to the first edge of the wall, a spindle fixed proximate to a second edge of the wall where the spindle is configured to collect and release the first cable from the second end of the first cable and the second cable from the second end of the second cable, and a spindle drive in communication with the spindle.

In another embodiment, a tensioning mechanism for a shipping container is described comprising a plurality of cables fixed proximate to a first edge of a container and a spindle system configured to collect one or more tension cables from a second edge of the container when the container is expanded and release one or more tension cables from the second ends when the container is collapsed. In yet another embodiment, a collapsible shipping container is described comprising a container structure having a first longitudinal side, a first lift beam pivotably disposed adjacent to a first corner of the first longitudinal side and slidably disposed proximate to a first edge of the first longitudinal side, and a second lift beam pivotably disposed adjacent to a second corner of the first longitudinal side and slidably disposed proximate to the first edge of the first longitudinal side.

In another embodiment, a collapsible shipping container is described including a container structure having a first longitudinal side and a second longitudinal side; a front lift beam having a first end and second end, where the first end is pivotably disposed adjacent to a first corner of the first longitudinal side and the second end is slidably disposed proximate to a first edge of the first longitudinal side; and a back lift beam having a first end and second end, where the first end is pivotably disposed adjacent to a first corner of the second longitudinal side and the second end is slidably disposed proximate to a first edge of the second longitudinal side. The position of the back lift beam relative to the container is symmetrical to the front lift beam relative to the container. The container further includes a first screw system coupled to the second end of the first lift beam and a second screw system coupled to the second end of the second lift beam.

In a further embodiment, a lifting mechanism is described comprising a drive shaft, a screw system in communication with the drive shaft where the screw system has a first screw receptacle and a first screw, and a first lift beam having a first end mechanically coupled to the screw receptacle and a second end pivotably fixed.

In another embodiment, a collapsible container is described comprising a collapsible container structure; a first screw fixed relative to a first edge of the collapsible container structure; a first drive shaft mechanically coupled to the first screw; and a first screw receptacle in threaded engagement with the first screw and in mechanical communication with the container such that when the first screw receptacle advances, the container collapses and when the first screw receptacle regressed, the container expands.

In yet another embodiment, a locking system is described that includes a door of a structure; a door frame coupled to the first door and pivotably coupled to the structure; and a lock handle pivotably disposed on a door, configured to have a first position in a first phase of a locking system. The lock handle is configured to have a second position in a second phase of a locking system and a third position in a third phase of a locking system.

### BRIEF DESCRIPTION OF THE DRAWINGS

FIG. 1 is a perspective view of a container consistent with the technology disclosed herein.

FIG. 2 is a perspective view of the container after a first phase of collapse.

FIG. 3 is a perspective view of the container in a second phase of collapse.

FIG. 4 is a perspective view of the collapsed container.

FIG. 5 is an end view of the collapsed container.

FIG. 6 is a side view of the collapsed container.

FIG. 7 is a view of detail A in FIG. 4.

FIG. 8A is a cross sectional view of an example hinge connection.

FIG. 8B is a cross sectional view of another example hinge connection.

FIG. 9 is a cross section of an additional example hinge connection.

FIG. 10A is a front view of the closed container door locked.

FIG. 10B is an exploded view of the closed container door of FIG. 10A.

FIG. 10C is close-up top view of a locking handle of the container door of FIGS. 10A and 10B.

FIG. 10D is close-up perspective view of an end cap of a support rod of the container door of FIGS. 10A and 10B.

FIG. 11 is a front view of the closed container door in a partially locked configuration.

FIG. 12 is a perspective view of the open container door folded down.

FIG. 13 is a front view of the container door with one side open.

FIG. 14 is a perspective view of the open door unlocked with one side open.

FIG. 15A is a cross-sectional view depicting the door closed against the container top.

FIG. 15B is a cross-sectional view depicting the door closed against the container side.

FIG. 15C is a cross-sectional view depicting the door closed against the container bottom, through a door hinge.

FIG. 16 is a perspective view of an example collapsing mechanism.

FIG. 17 is a cut-away view of a column with a joint plate in a first position.

FIG. 18 is a cut-away view of a column with a joint plate in a second position.

FIG. 19 is a perspective view of a joint plate.

FIG. 20 is a top view of the top of the container depicting the cable system.

FIG. 20A is a perspective view of detail B of FIG. 20.

FIG. 20B is a perspective view of detail B of FIG. 20 at a different viewing angle than that of FIG. 20A.

FIG. 20C is a perspective view of detail C of FIG. 20.

FIG. 20D is a view of detail D of FIG. 20.

FIG. 20E is a view of detail E of FIG. 20.

FIG. 21 is a side view of the container depicting the cable system.

FIG. 21A is a view of detail H of FIG. 21.

FIG. 21B is a view of detail I of FIG. 21.

FIG. 21C is a view of detail J of FIG. 21.

FIG. 22 is a perspective view of a triple cable connection.

FIG. 23 is a perspective view of a single cable connection.

FIG. 24A is a cross-sectional view of an example pulley system along line A′ depicted in FIG. 24B.

FIG. 24B is a cut-away perspective view of the example pulley system of FIG. 24A.

FIG. 25A is a perspective view of a container with a front wall partially collapsed.

FIG. 25B is a zoomed-in perspective view of the container relative to FIG. 25A with the front wall partially collapsed.

FIG. 26 is a perspective view of a drive shaft lock.

FIG. 27 is a front view of the drive shaft lock.

FIG. 28 is a side view of the drive shaft lock.

FIG. 29 is a perspective view of detail F of FIG. 20.

FIG. 30 is a perspective view of detail G of FIG. 20.

FIG. 31 is a perspective view of a slip gear system.

FIG. 32 is an exploded view of a slip gear system.

FIG. 33 depicts an example power take-off (PTO) device.

FIG. 34 is a perspective view of the example PTO of FIG. 33 connected to the container.

FIG. 35 is a front view of the example PTO of FIG. 33 connected to the container.

FIG. 36 depicts the example PTO of the FIG. 34 connected to the container where the PTO is starting to collapse the container.

FIG. 37 depicts the example PTO of FIG. 34 connected to the container where the PTO has collapsed the container.

FIG. 38 depicts a stack of collapsed shipping containers.

FIG. 39 is a perspective view of an alternative embodiment of the container disclosed herein in an erect position

FIG. 40 is a perspective view of the alternative embodiment of the container of FIG. 39, in a partially collapsed position.

FIG. 41 is a perspective view of the alternative embodiment of the container of FIG. 39, in a collapsed position.

FIG. 42 is a side view of the example container of FIG. 39 in an erect position.

FIG. 43 is a side view of the alternative container of FIG. 39 in a partially collapsed position.

FIG. 44 is a side view of the example container of FIG. 39 in a fully collapsed position.

FIG. 45 is a front view of the alternative embodiment of the partially collapsed container of FIG. 39.

FIG. 46 is a front view of the alternative embodiment of the fully collapsed container.

FIG. 47 is a perspective view of an alternative embodiment of one corner of a collapsed container consistent with container depicted in FIG. 39.

FIG. 48 is a perspective view of an alternative embodiment of an erected container door consistent with the technology disclosed herein.

FIG. 49 is a perspective view of the alternative embodiment of the container door in a partially collapsed position, consistent with the technology disclosed herein.

FIG. 50 is a perspective view of the alternative embodiment of the container door in a collapsed position, consistent with the technology disclosed herein.

FIG. 51 is a front view of a bottom hinge in an erect position consistent with an alternative embodiment of the technology disclosed herein.

FIG. 52 is a front of the bottom hinge of FIG. 42a in a partially collapsed position.

FIG. 53 is a front view of a central hinge in an erect position consistent with an alternative embodiment of the technology disclosed herein.

FIG. 54 is a front of the central hinge of FIG. 50 in a partially collapsed position.

FIG. 55 is a front view of a top hinge in an erect position consistent with an alternative embodiment of the technology disclosed herein.

FIG. 56 is a front of the top hinge of FIG. 52 in a partially collapsed position.

FIG. 57 is a cut-away side view of a cable system consistent with the alternative embodiment of the container.

FIG. 58 is a perspective view of the alternative embodiment of the container of FIG. 39 revealing the container top.

FIG. 59 is a top view of the alternative embodiment of the container.

FIG. 60 is a bottom view of the alternative embodiment of the container.

FIG. 61 is a perspective view of a pulley system consistent with the alternative embodiment of the container.

FIG. 62 is a detail view of section M as depicted in FIG. 41.

FIG. 63 is another detail view of section M as depicted in FIG. 41.

FIG. 64 depicts stacked collapsed containers compared to a single erected container consistent with the alternative embodiment of the container.

FIG. 65 depicts a front view of stacked collapsed containers compared to a single erected container consistent with the alternative embodiment of the container.

FIG. 66 depicts a perspective view of stacked erected containers compared to a single erected container consistent with the alternative embodiment of the container.

The invention may be more completely understood and appreciated in consideration of the following detailed description of various embodiments of the invention in connection with the accompanying drawings.

### DETAILED DESCRIPTION

### Container Overview

Shipping containers are available in many different sizes, but one common size has dimensions about 8 feet (W) by 8.5 feet (H) by 40 feet (L). Another common size is 8 feet (W) by 9.5 feet (H) by 40 feet (L), which is sometimes referred to as a “High Cube” size. The High Cube size has been increasing in popularity in recent years. Principles disclosed herein relevant to the High Cube design could be applied to containers of other sizes, especially those of different lengths. For example, other common sizes have similar height and width dimension, but a length dimension of 20 feet, 45 feet, or 53 feet. The below-described technology can also be relevant to the 8 feet (W) by 8.5 feet (H) by 40 feet (L) container, as well as other-sized containers.

### General Structure of Container

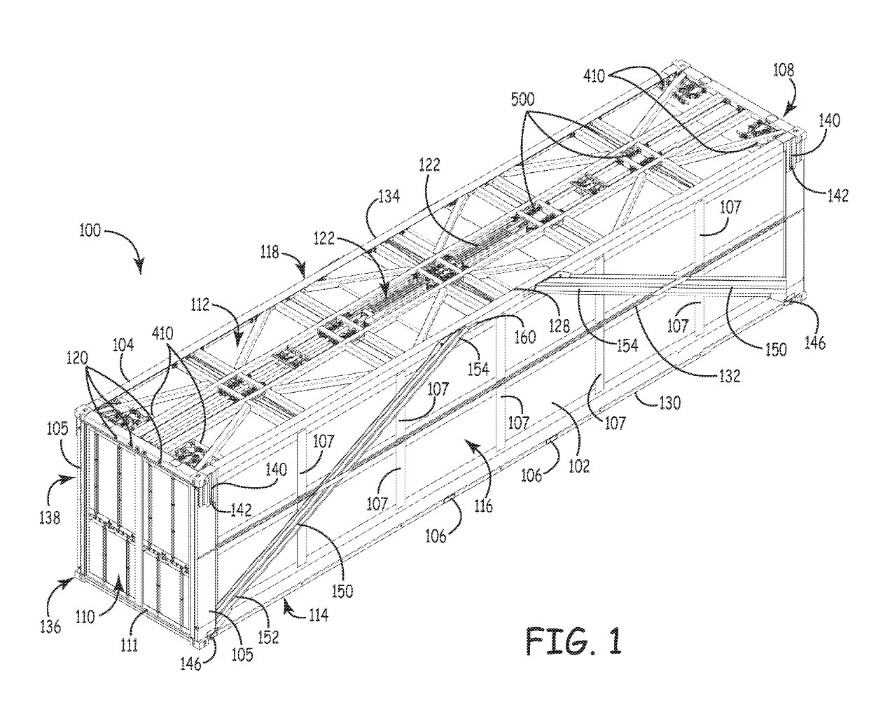

FIG. 1 is a perspective view of a container consistent with the technology disclosed herein. The container 100 broadly is constructed of panels 102 and a skeletal structure 104, and defines an interior that is configured to hold goods for shipment, storage, and the like. The container 100 has an end panel not visible in FIG. 1, a container door 110, a container top 112, a container bottom 114, a container first longitudinal side 116, and a container second longitudinal side 118 (also not visible in FIG. 1). Both the first longitudinal side 116 and the second longitudinal side 118 have a hinge along an intermediate axis 132 across the length of each respective side. Power Take-Off (PTO) inputs 120 are defined by the container 100 and can be used to collapse and expand the container. Fork lift tine sleeves 106 are defined by the container 100 by which the container 100 can receive fork lift tines and therefore be transferred, loaded, and unloaded.

The skeletal structure 104 is generally a truss structure formed from steel beams, fiberglass and composite material, for example, although a variety of materials would provide suitable strength and durability. Such truss structure can define the perimeters of the container end panel 110, the container door 110, the container top 112, the container bottom 114, the container first longitudinal side 116, and the container second longitudinal side 118. The skeletal structure 104 has at least four hinged columns 105 adjacent to at least four edges of the container 100 where the hinges allow collapse of the container.

The skeletal structure 104 can provide support for the panels 102 by, for example, sandwiching the perimeter of the panels 102 to protect the edges of the panels 102. The skeletal structure 104 can be coupled to the panels using a variety of mechanisms such as latches, bolts, and the like. The skeletal structure 104 also can include elongate U-shaped members, in some embodiments constructed of steel and/or a fiberglass material and/or a composite material, which substantially cover the edges of the panels 102. Additionally, the beams incorporated into the skeletal structure 104 can be bolted together, hinged together, or coupled through a variety of other means known in the art.

In the current embodiment the jointed columns 105 are adjacent to the four vertical edges of the container 100. A plurality of vertical bracing elements 107 can also define the skeletal structure 104. In the embodiment depicted the vertical bracing elements 107 are parallel to the jointed columns 105 and disposed incrementally along the length of each longitudinal side 116 and placed between 1) the truss structure defining the perimeter of the container top and the intermediate hinge 132 and 2) the truss structure defining the perimeter defining the container bottom and the intermediate hinge 132.

The panels 102 can be a variety of materials and combinations of materials, but in at least one embodiment are at least partially composed of composite material. In such an embodiment the composite panels can have a corrugated structure, and are generally rectangular in shape. In such embodiments the panels 102 can also be constructed of foam, a variety of plastics, and the like. In one embodiment the composite material sandwiches a plastic material. In one other embodiment the composite material sandwiches a foam material that is sprayed on the composite material, where air between the layers of composite material and the foam is vacuumed out for increased strength. In yet another embodiment, the panels 102 are constructed of a fiberglass honeycomb structure, where expanding foam is used to fill the voids defined by such honeycomb structure. Cross-bracing can be incorporated within the structure of the panels 102. In various embodiments the panels 102 are permeable to some forms of electromagnetic radiation such as X-radiation (X-rays).

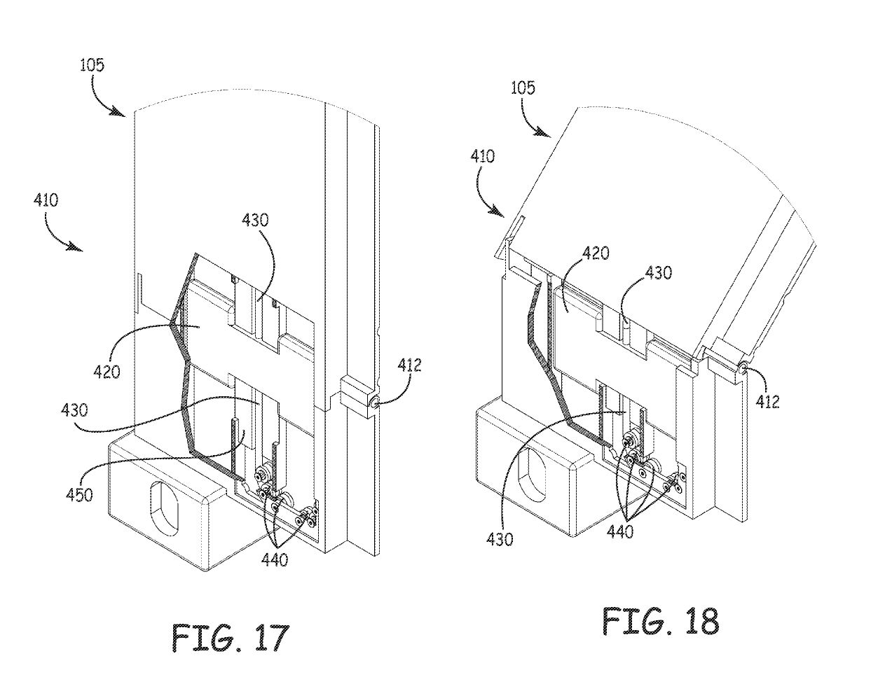

In at least one embodiment, the panels 102 define one or more openings and channels through which to pass one or more translating cables, which will be described in more detail, in the discussion of FIGS. 17, 18 and 21, below. Panels 102 can be coupled to the skeletal structure 104 through a variety of means including bolts, hinges, various adhesive materials, and through any other means and combinations of means generally known in the art.

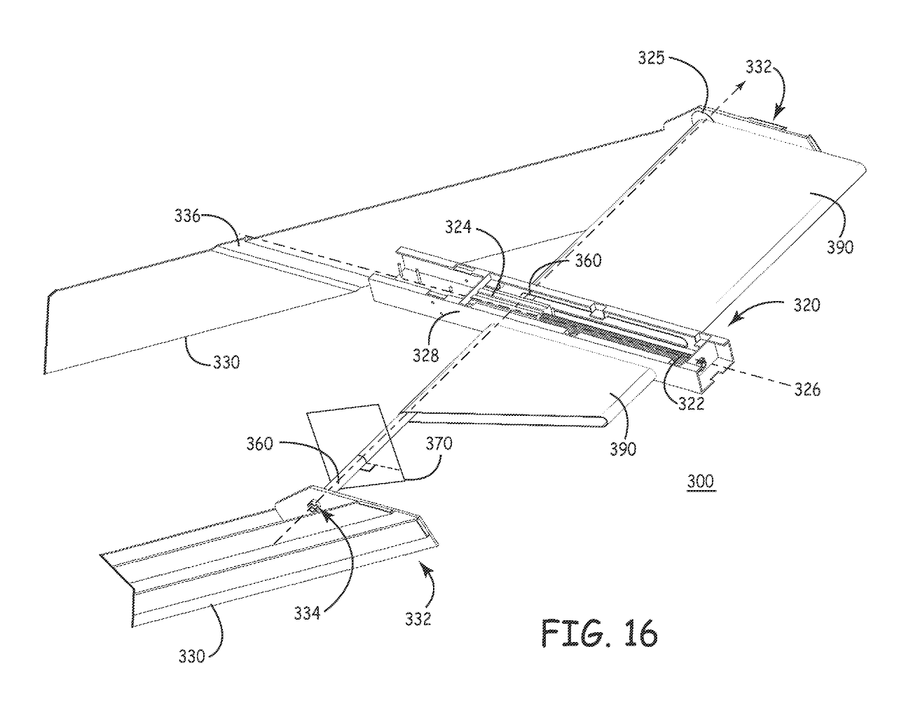

The top 112 of the container 100 is at least partially defined by the panels 102 and skeletal structure 104 and incorporates at least a portion of a variety of mechanisms that contribute to the collapsing and expanding process of the container 100. A collapsing mechanism 122 including lift beams 150 is used for directly collapsing and expanding the container 100. A tensioning mechanism 500 is used for providing tension within the longitudinal sides 116, 118 as the container is expanded and removing tension within the longitudinal sides 116, 118 when the container is collapsed. A joint support system is at least partially incorporated in the top 112 of the container to provide support to column 105 hinges of the container 100 when the container 100 is erect. Such mechanisms will be described in more detail in the discussions of FIGS. 16-24 below, among others.

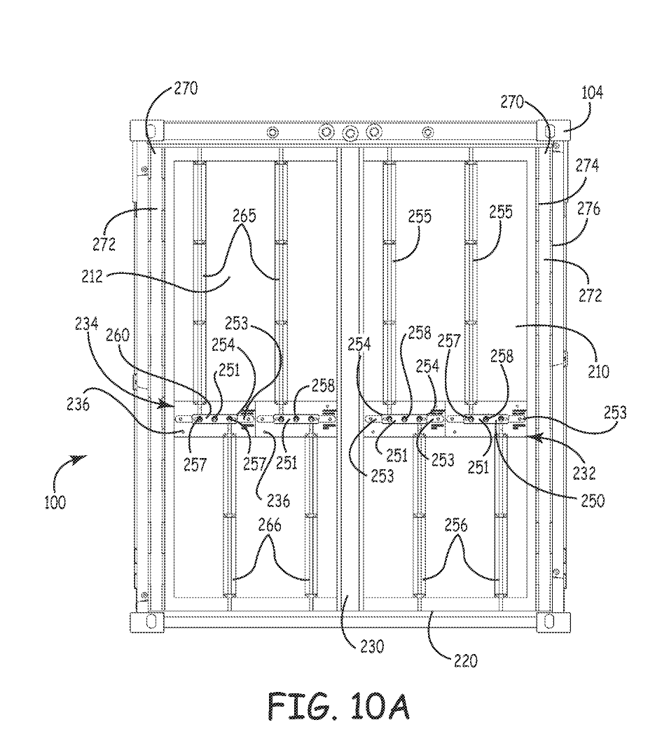

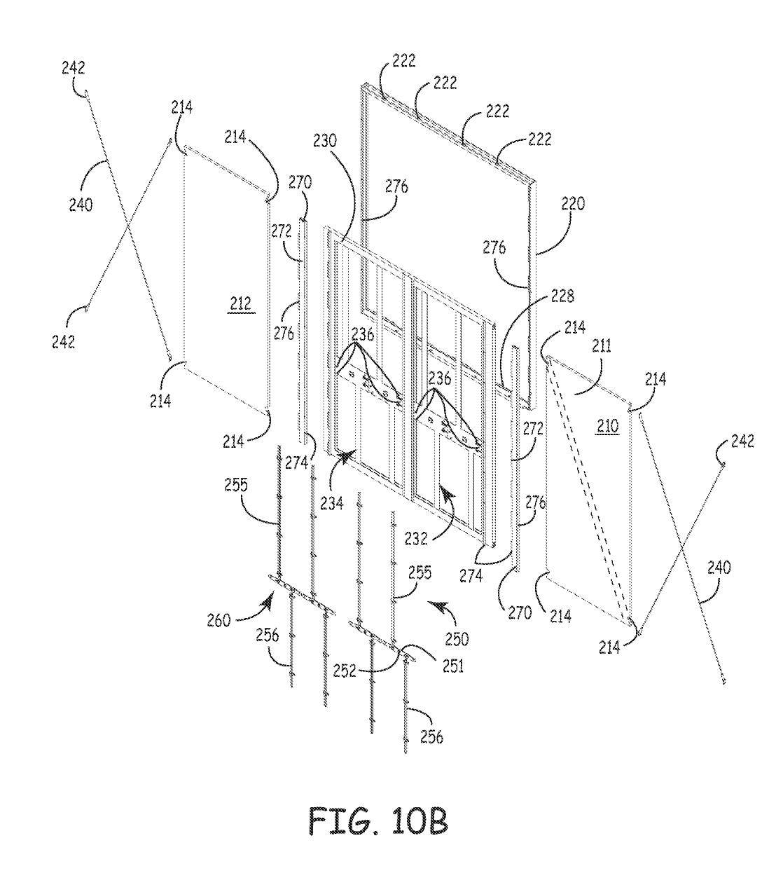

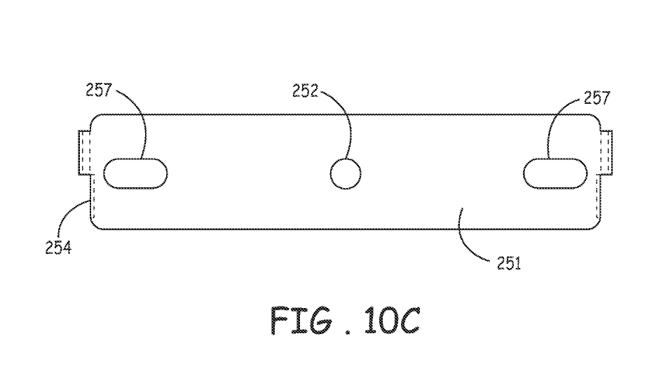

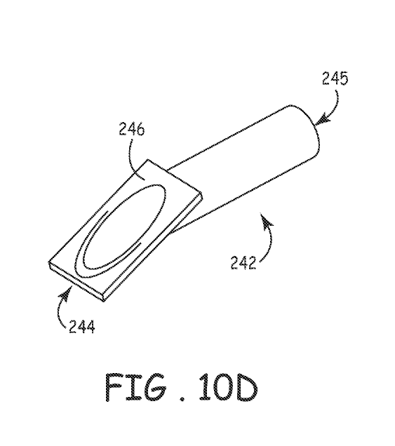

The container door 110 is coupled to a perimeter of the container forming an aperture. In one embodiment the perimeter of the aperture is defined by the skeletal structure 104 of the container 100. In another embodiment the perimeter of the aperture is defined by outer end edges of the panels 102. The container door 110 can be coupled to the skeletal structure 104, panels 102, or the like, through a variety of means that will be known in the art. In one embodiment the container door 110 is coupled to the substantial length of the material defining the bottom edge of the aperture with a hinge that allows folding of the container door 110 into the container 100. The container door 110 will be described in more detail in the discussion of FIGS. 10-15, below.

### General Description of Collapsing

In one particular embodiment, the collapsing mechanism 122 is in operative communication with lift beams 150. The container 100 has four lift beams 150, where a first end 152 of each of the four lift beams 150 is pivotably disposed adjacent to a unique bottom corner of each longitudinal side 116, 118 of the container 100. In some instances the container 100 has up to eight lift beams, which will be described below. A second end 154 of each of the four lift beams 150 is slidably disposed in a sliding slot 160 defined along the top of the container 100. When engaged for collapse, the collapsing mechanism 122 slides the second end 154 of each of the four lift beams 150 along the sliding slot 160 towards the center of the container 100, causing the lift beams 150 to pivot and the second end 154 of each lift beam to move downwardly. The lift beams 150 guide the collapse of the structure of the container 100. The collapsing process is generally described with reference to FIGS. 1-4, where each of FIGS. 1-4 demonstrates a particular phase in the collapsing process.

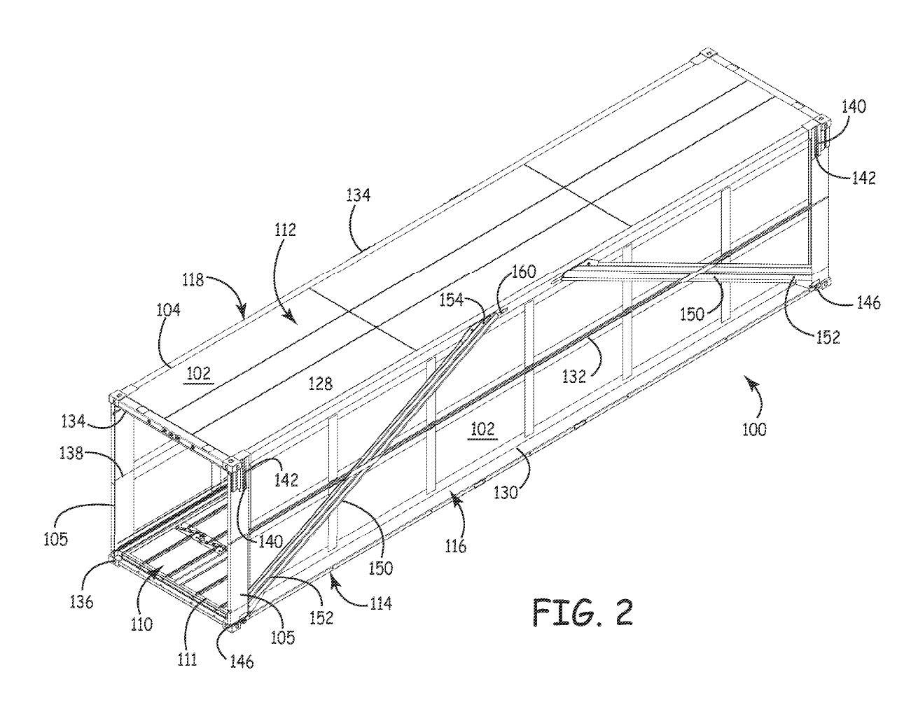

FIG. 2 depicts the container with its end panel (not visible) and door 110 in a collapsed position in the container 100. The end panel is configured to fold into the container 100 along the bottom edge of the end panel, and the door 110 is configured to fold into the container 100 along the bottom edge 111 of the door 110. It will be appreciated that an end panel and/or the door 110 can be configured to fold into the container 100 along the top edge of the container in an embodiment. Although the description will refer to both end walls being configured as openable doors, it is possible for the container to incorporate one end panel and one door.

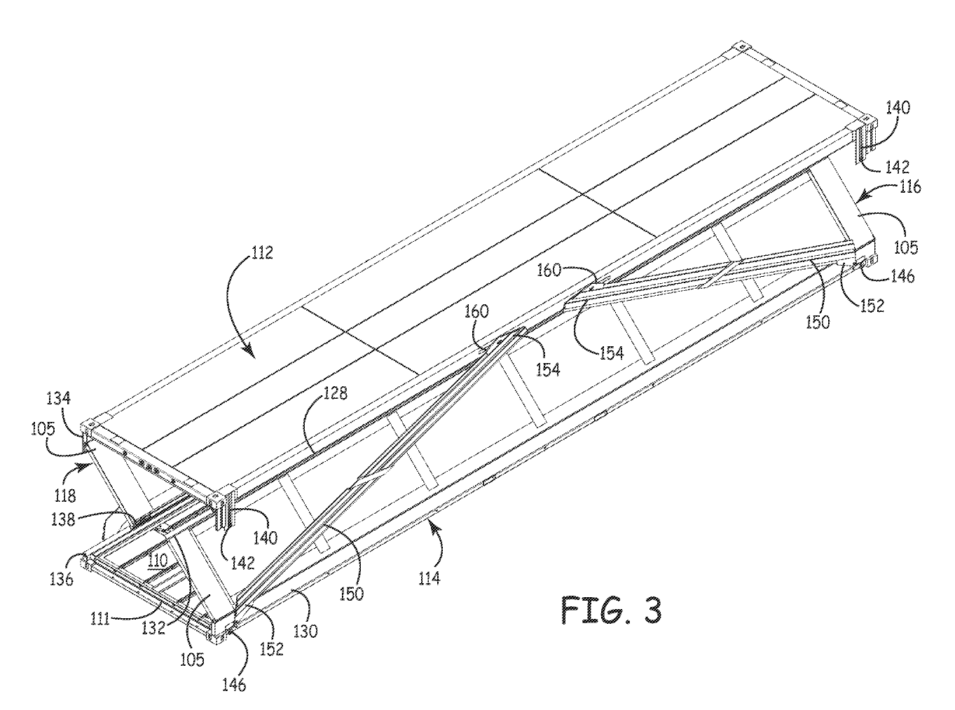

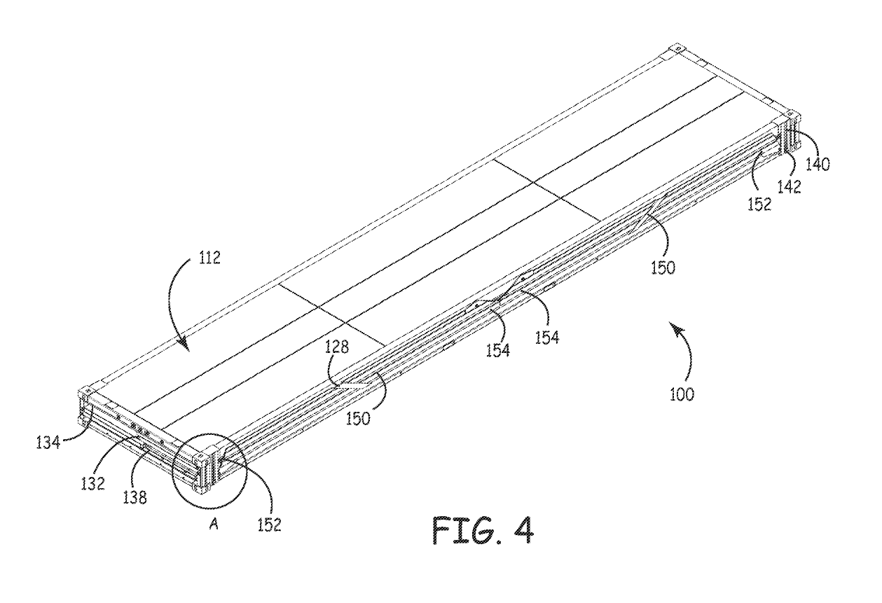

FIG. 3 is a perspective view of the container in a second phase of collapse. The container first longitudinal side 116 is hinged at the top edge 128, the bottom edge 130 and along an intermediate axis 132, such that the first longitudinal side 116 folds inwardly as a result of the second ends 154 of the lift beams 150 pivoting downward about the first ends 152 of the lift beams 150. The container second longitudinal side 118 is likewise hinged at its top edge 134, bottom edge 136, and along an intermediate axis 138, such that the second longitudinal side 118 folds inwardly. As a result, the shipping container 100 can change from an upright configuration depicted in FIG. 1 to a folded configuration depicted in FIG. 4.

In one embodiment, the folded configuration is ⅙th of its upright height. For example, 8 feet (W) by 8.5 feet (H) by 40 feet (L) container can be collapsed to have dimensions of about 8 feet (W) by 17 inches (H) by 40 feet (L).

In another embodiment, the folded configuration is ⅕^{th} of its upright height. For example, a container having dimensions of about 8 feet (W) by 9.5 feet (H) by 40 feet (L) can be collapsed to have dimensions of about 8 feet (W) by 22.8 inches (H) by 40 feet (L).

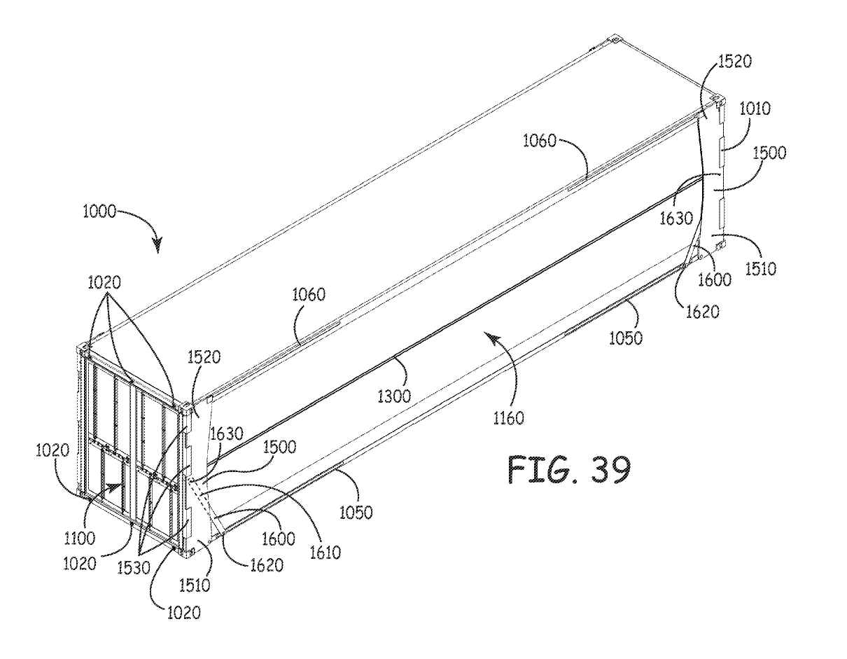

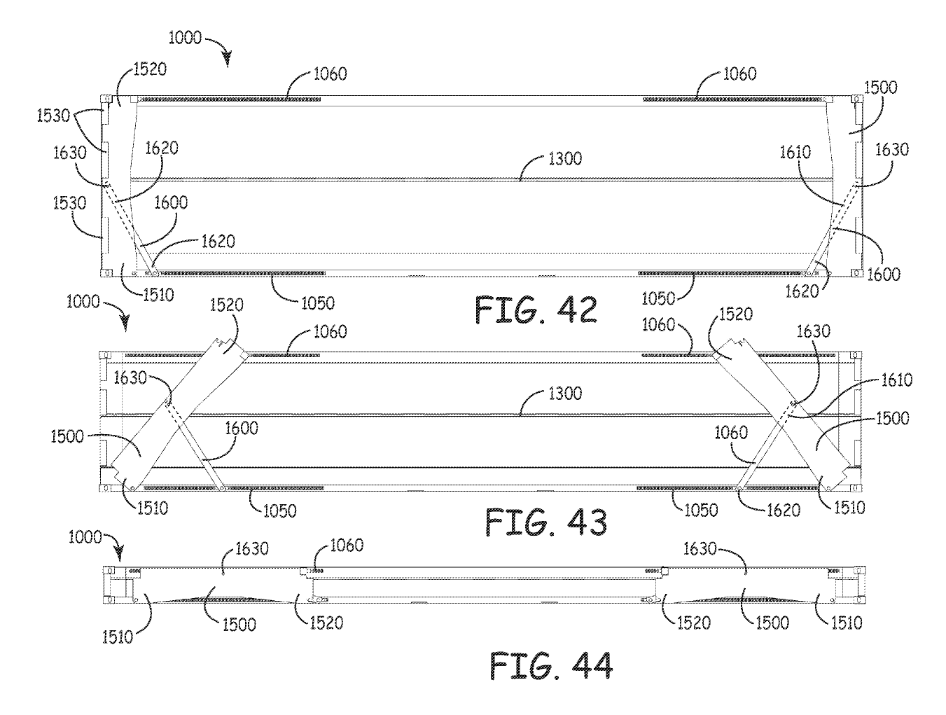

Now the collapsing of a container 1000 having an alternative embodiment will be described, referring to FIGS. 39-46. The general collapsing process of the container 1000 depicted in FIGS. 1-4 can be similar to the collapsing process of the container 1000 of the embodiment depicted in FIGS. 39-46.

Each of four primary lift beams 1500 have a first end 1510 that is pivotably disposed adjacent to a unique bottom corner of each longitudinal side of the container, and a second end 1520 that is slidably disposed in a top sliding slot 1060 defined along the top of the container. However, each of the four primary lift beams 1500 works in concert with a secondary lift beam 1600. Each secondary lift beam 1600 has a first end 1610 that is pivotably disposed at a point 1630 that is central to the length of the respective primary lift beam 1500, and a second end 1620 that is slidably disposed in a bottom sliding slot 1050 defined along the bottom of the container 1000. In the alternative embodiment, both the primary lift beams 1500 and the secondary lift beams 1600 guide the collapse of the structure of the container 1000.

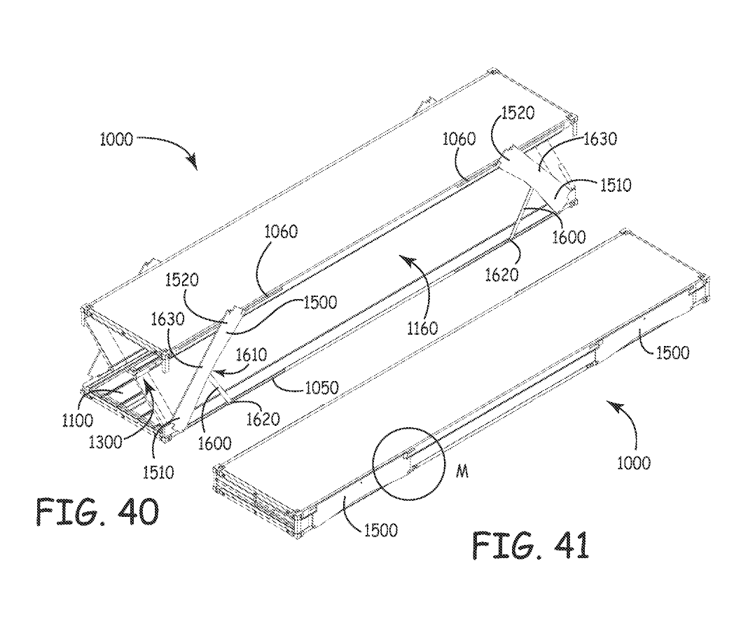

FIG. 40 is a perspective view of the alternative embodiment of the container 1000 depicted in FIG. 39 in a partially collapsed position. Similar to the embodiment depicted in FIG. 3, the end panel 1100 is configured to fold into the container 1000 along the bottom edge of the end panel 1100, where the end panel 1100 can be a door for accessing the container 1000 contents when upright. Each of the longitudinal sides 1160 folds inwardly relative to the outside of the container 1000 as a result of the second ends 1520 of the primary lift beams 1500 slide inwards towards the center of the container 1000, pivoting downward about the first ends 1510 of the primary lift beams 1500 and the second ends 1620 of the secondary lift beams 1600 slide inwards towards the center of the container 1000, pivoting downward about the pivot point 1630 of the secondary lift beams 1600. As will be described in the description of FIGS. 16, and 58-60, a screw system can be the collapsing mechanism in a variety of embodiments. The screw system can be configured such that the container collapses when the screw system advances, and the container expands when the screw system regresses. For example, as the screw system regresses, the second ends of the lift beams slide along their respective sliding slots away from the center of the container, causing the lift beams to pivot upward, further causing expansion of the container. As mentioned above, the collapsing mechanism will be described in more detail below.

### Description of Container Assymmetry

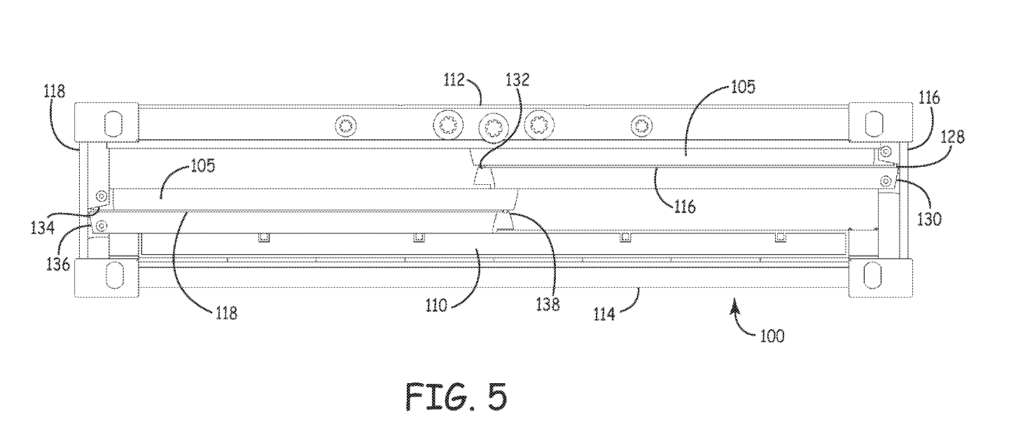

FIG. 5 is an end view of the collapsed container. The container top 112 and container bottom 114 sandwich the folded first longitudinal side 116, the folded second longitudinal side 118 and the container door 110. From this view it is possible to see that the container first longitudinal side 116 is not identical to the container second longitudinal side 118.

The top edge 128, bottom edge 130, and intermediate axis 132 of the first longitudinal side 116 are at different positions relative to the height of the container 100 than the top edge 134, bottom edge 136, and intermediate axis 138 of the second longitudinal side 118. Such a construction as depicted and described can allow each longitudinal side 116, 118 to fold inwardly and at least partially overlap so as to accommodate each other. As a result, the shipping container 100 can collapse from an upright configuration to a folded configuration where it is a fraction of its upright height.

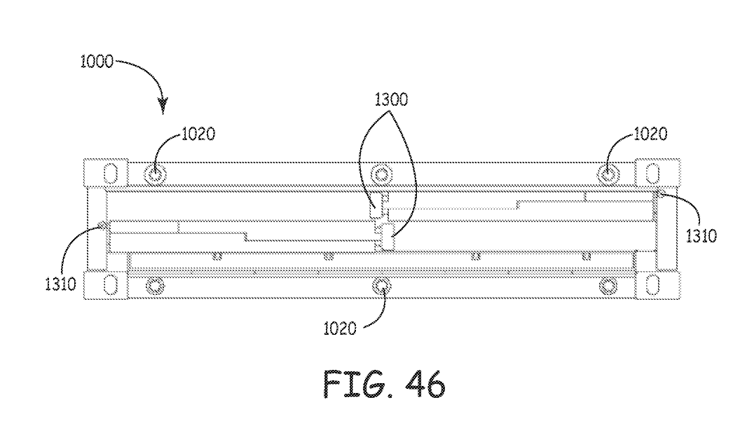

FIG. 46 depicts an end view of a collapsed container similar to the alternate embodiment depicted in FIG. 39.

### Locking Plate

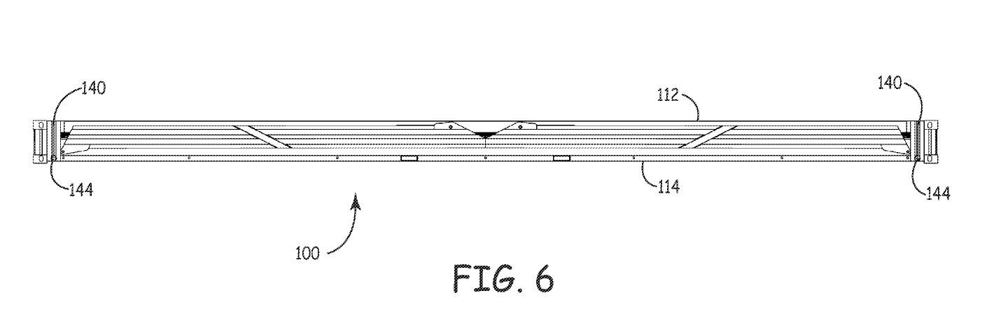

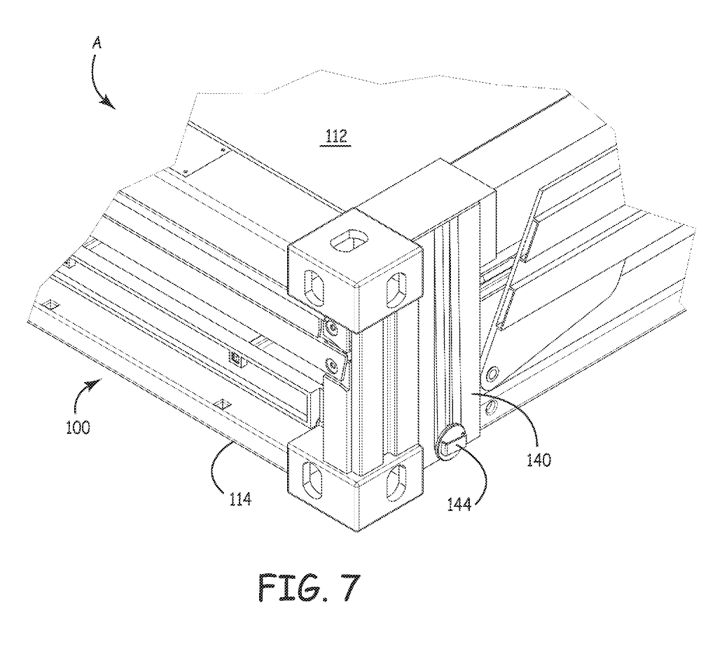

FIG. 6 is a side view of the collapsed container, and FIG. 7 is a view of detail A in FIG. 4. A lock is incorporated in the container 100 that is configured to engage the container top 112 and the container bottom 114 when the container is collapsed to prevent relative movement of the container top 112 to container bottom 114, that is, to lock the container 100 in the collapsed position. The lock can have a variety of configurations and remain within the scope of the technology disclosed herein. In this particular embodiment, the lock has a locking plate 140 that is coupled to the container top 112 and a locking pin 144 to removably couple the locking plate 140 to the container bottom 114.

The locking plate 140 defines a plate pin opening 142 that is configured to receive a locking pin 144. The locking plate 140 extends towards the container bottom 114 and is configured such that when the container 100 is in a collapsed position, the plate pin opening 142 substantially aligns with a container pin opening 146 (where the container pin opening 146 can be viewed in FIG. 1) defined by the container bottom 144. The plate pin opening 142 and the container pin opening 146 collectively form a passage for the locking pin 144. The locking pin 144 is configured to prevent relative motion between the container top 112 and the container bottom 114 when the container is in a collapsed state.

The locking plate 140 can be constructed of a variety of materials and fall within the scope of the technology disclosed herein. In a variety of embodiments the locking plate 140 is rigid. In such embodiments the locking plate 140 can be constructed of steel and/or a composite material, for example. The locking plate can be secured to the container top 112 via rivets, bolts, and the like, and holds the collapsed container 100 structure together. The locking plate 140 can be secured to a variety of other locations on the container 100 and be included within the scope of the technology disclosed herein.

The lock can be incorporated in at least one location on the container 100, or each of the four top corners of the container 100 can have a locking plate 140 coupled thereto, and each of the four bottom corners can be configured to receive a locking pin 144 through a passage defined by a container pin opening 146 and plate pin opening 142 of a corresponding locking plate 140. The locking pin 144 can be placed for storage in the container pin opening 146 when the container 100 is fully erected, in multiple embodiments.

The locking pin 144 is configured to engage the locking plate 140 and the container bottom 114, and therefore can have a variety of shapes and sizes to achieve such. In one embodiment the locking pin 144 is cylindrical and is 3⅞ inches long and 1.5 inches thick. The locking pin can be constructed of steel in one embodiment, although a variety of other materials would be suitable without deviating from the scope of the technology disclosed herein. In a variety of embodiments the locking pin 144 is non-load-bearing unless forces are applied to the container 100 separating the container top 112 and the container bottom 114 while the pin is disposed in the container pin opening 146 and the plate pin opening 142. When the container is collapsed, the locking plate 140 rests against the corner of the container bottom, so the locking plate 140 and not the locking pin 144 bears the weight of the top of the container and any containers stacked on top of it.

The locking pin 144 can be constructed to frictionally engage at least a portion of the locking plate 140 or container bottom 114 from the passage defined by the container pin opening 146 and plate pin opening 142 of a corresponding locking plate 140. In one example embodiment, two or more spheres disposed on the end of the locking pin 144 provide frictional engagement with at least a portion of the surfaces defining the passage. In another embodiment the locking pin 144 can be rotated into place with threading corresponding to threading defined by at least a portion of the surfaces defining the passage. In yet another embodiment the locking pin 144 can have a mating connection with at least portion of the surfaces defining the passage. Also, at least a portion of the surfaces defining the passage can be configured to provide frictional engagement with the locking pin 144.

In one embodiment the locking pin 144 is spring-loaded in the container-pin opening in the container bottom 114, for example, and is triggered to release into the plate pin opening 142 when the container 100 is fully collapsed. This can be accomplished through employing a trigger, for example, that is mechanically engaged by a portion of the container 100, such as the container top 112, when the container 100 is fully collapsed. Those skilled in the art will appreciate that other mechanisms for automatically engaging the locking pin 144 upon collapse of the container 100 can be employed.

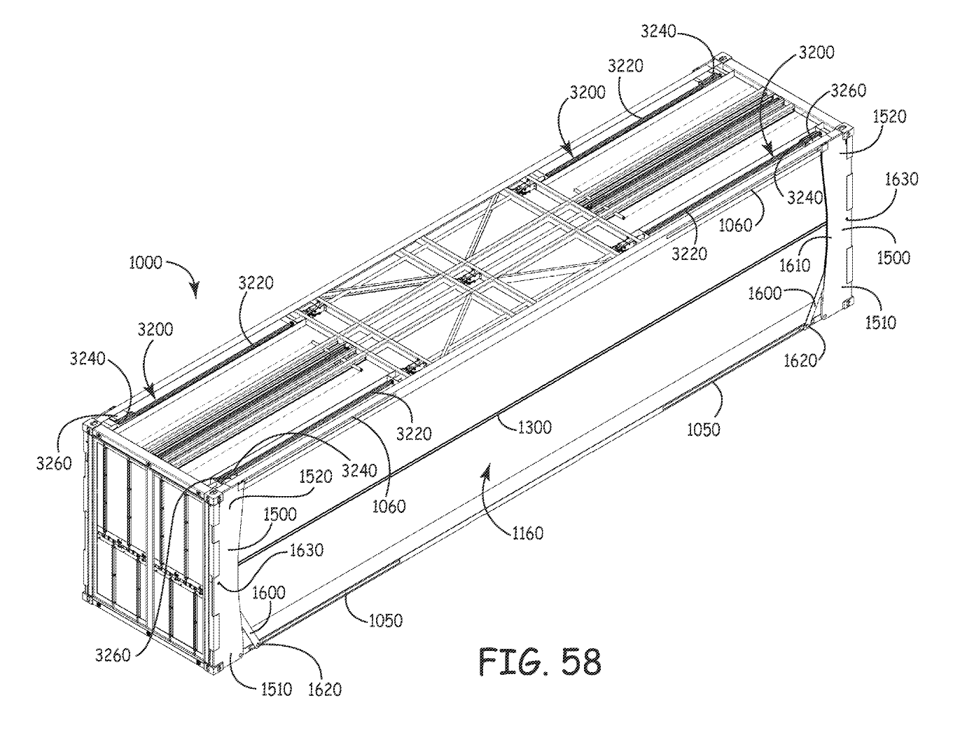

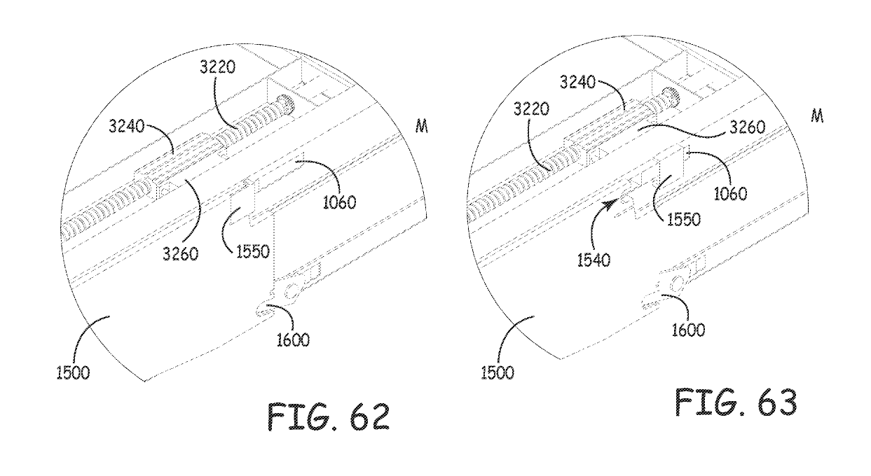

In an alternate embodiment, such as the one depicted in FIG. 39, the functionality of the locking pin and plate is incorporated in other mechanisms of the shipping container. FIGS. 62 and 63 depict detail M of FIG. 41, and demonstrate two stages of the same alternate configuration. Once the container 1000 is lowered to a collapsed state (refer to FIG. 41) the corner post rest upon the bottom of the container connection plate similar to the design found in FIG. 7. The screw 3220 associated with the primary lift beam 1500 is further rotated while the screw associated with the secondary lift beam (See FIGS. 58 and 60) remain still. The sliding connector 3260 is mechanically coupled to the screw receptacle 3240 and disconnects from the second end 1520 of the primary lift beam 1500 as the screw receptacle 3240 laterally translates further towards the center of the container 1000. Once the engagement pin 1550 is removed, the secondary lift beam 1600 releases and shifts towards the center of the container, allowing the primary lift beam 1500 to further collapse to a substantially horizontal orientation. When the primary lift beam 1500 is in a substantially horizontal state, the screw 3220 is rotated in the opposite direction to progress the screw receptacle 3240 and, therefore, the sliding connector 3260 away from the center of the container. An engagement pin 1550 defined by the sliding connector 3260 (or coupled to the sliding connector 3260) translates towards, and engages, a into the pin groove 1540 of the primary lift beam 1500.

At this time the secondary lift beam 1600 will not be in motion. This will “lock” the container 1000 in its collapsed state. Those skilled in the art will appreciate that other configurations of the locking pin and its placement onto/into the main lift beam 1500 would fit within the scope of the technology disclosed herein.

### Hinge Configurations

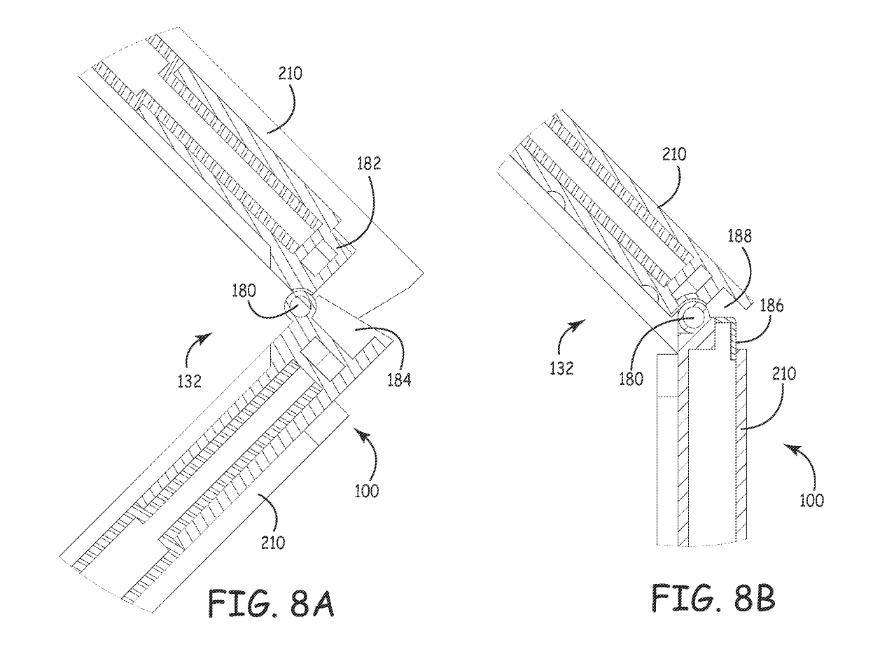

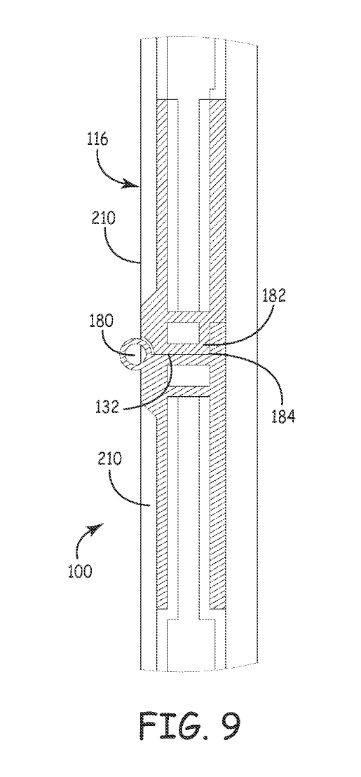

FIG. 8A is a cross sectional view of an example hinge connection in a folded position. FIG. 8B is a cross sectional view of another example hinge connection in a folded position. FIG. 9 is a cross sectional view of the example hinge connection of FIG. 8A, in an unfolded position. The hinge connection 180 can be consistent with that along an intermediate axis 132 of a longitudinal side of a container 100. The longitudinal side can have a tongue-and-groove fit along the intermediate axis 132 to provide a seal along each edge. In the embodiments depicted in FIGS. 8A and 9, the top portion of the longitudinal side 132 has the “tongue” structure 182 and the bottom portion of the longitudinal side defines the “groove” structure 184. The embodiment depicted in FIG. 8B shows a hinge assembly along the container top and/or container bottom. The bottom portion of the longitudinal side defines the “tongue” structure 186 and the top portion of the longitudinal side 132 defines the “groove” structure 188. The tongue and groove structure deters water from entering the container along its hinged edges. The tongue and groove structures can be reversed and repositioned in a variety of embodiments and still be within the scope of the technology disclosed herein.

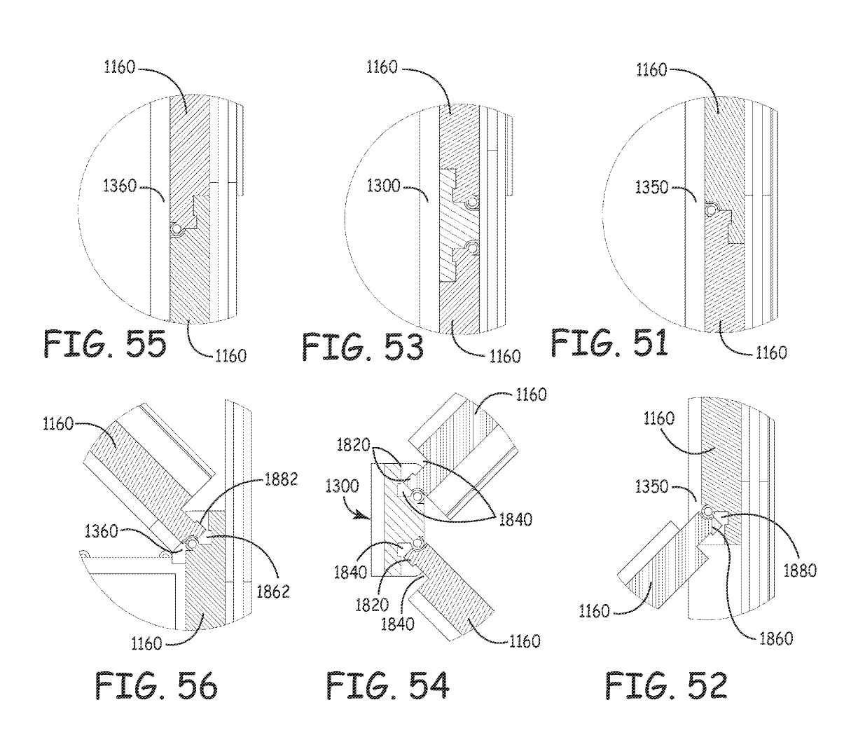

FIGS. 51-56 depicts hinge configurations similar to the alternate embodiment of the technology disclosed herein. FIG. 51 is a cross sectional view of an example hinge connection in a folded position. FIG. 52 is a cross sectional view of the example hinge connection of FIG. 51, in an unfolded position. FIG. 53 is a cross sectional view of another example hinge connection in a folded position. FIG. 54 is a cross sectional view of the example hinge connection of FIG. 53, in an unfolded position. FIG. 55 is a cross sectional view of another example hinge connection in a folded position. FIG. 56 is a cross sectional view of the example hinge connection of FIG. 55, in an unfolded position.

The embodiment depicted in FIGS. 51 and 52 show a hinge assembly along the container top and/or container bottom. The top portion of the longitudinal side 1160 defines the “groove” structure 1880 and the bottom portion of the longitudinal side 1160 defines the “tongue” structure 1860. The tongue and groove structure deters water from entering the container along the hinge 1350. The tongue and groove structures can be reversed and repositioned in a variety of embodiments and still be within the scope of the technology disclosed herein. The embodiment depicted in FIGS. 55 and 56 also show a hinge assembly 1360 along the container top and/or container bottom, where on one side of the hinge 1360 the longitudinal side 1160 defines a “tongue” 1882 and the other side of the longitudinal side 1160 defines a “groove” 1862.

The hinge connection of FIGS. 53 and 54 can be consistent with a hinge along an intermediate axis of a longitudinal side of a container similar to an alternative embodiment. The longitudinal side 1160 can have a tongue-and-groove fit along the intermediate axis (such as that depicted in FIG. 39) to provide a seal along each edge of the hinge 1300. In the embodiments depicted in FIGS. 53 and 54, both the hinge 1300 component and each side of the longitudinal side 1160 defines a “tongue” structure 1820 and a “groove” structure 1840.

### Container Door-Locking Mechanisms

FIG. 10A is a front view of the container door closed and locked, and FIG. 10B is an exploded view of the container door of FIG. 10. The container door 200 has a door frame 220 coupled to a door structure 230. The door structure 230 defines at least a first door 232. A first locking mechanism 250 is coupled to the first door 232 of the door structure 230. The first locking mechanism 250 is in mechanical communication with the door frame 220, where the first locking mechanism 250 allows and prevents access to the inside of the container. In this particular embodiment, the door structure 230 also defines a second door 234 that is coupled to a second locking mechanism 260. The first locking mechanism 250 and second locking mechanism 260 each have two lock handles 251 where each lock handle 251 is coupled to an upper lock rod 255 and a lower lock rod 256.

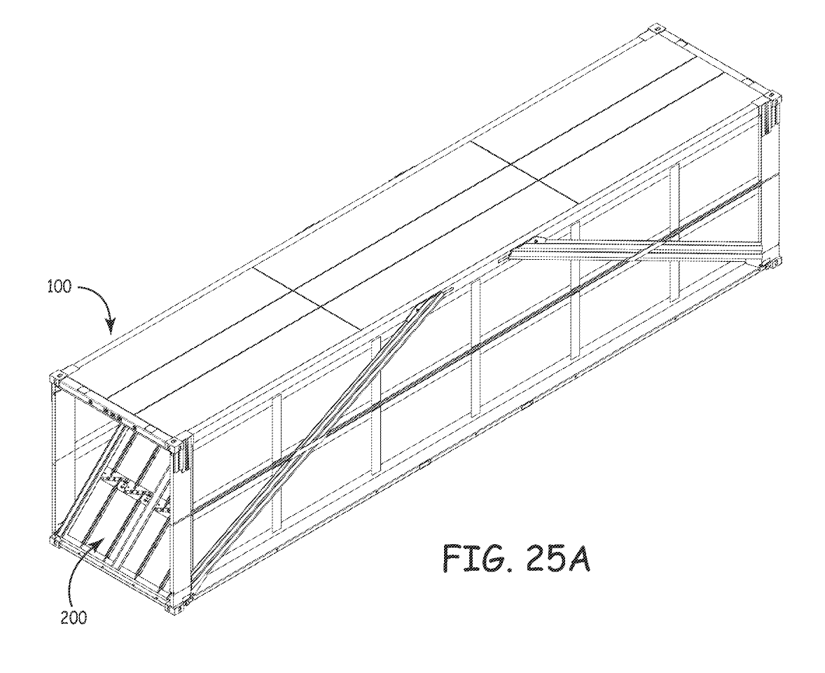

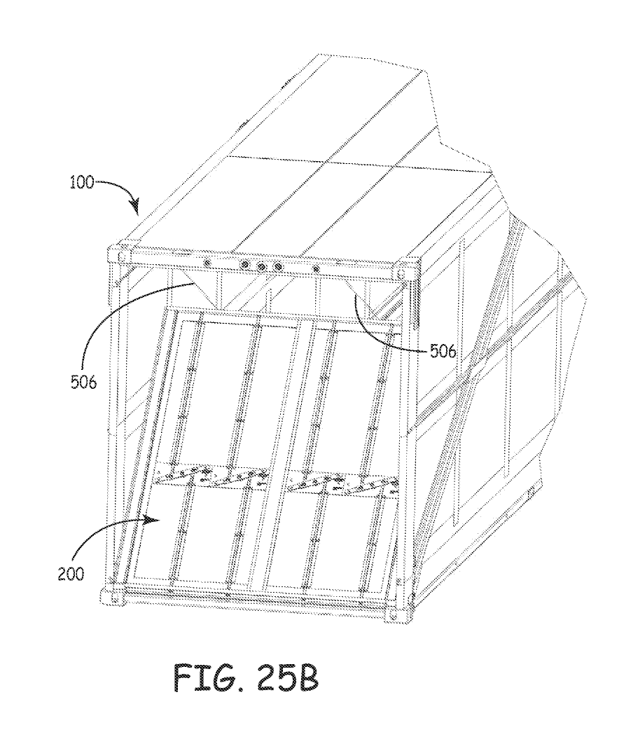

The container door 200 is generally configured to prevent and allow access to the inside of the container (not depicted) to load or unload the container. In the process where the container is collapsed, the container door 200 is folded within the container, which is described in more detail in the description of FIG. 25, below. In the current views, the first locking mechanism 250 and second locking mechanism 260 are fully engaged to prevent access to the inside of the container and also prevent the container door 200 from being folded within the container. Such a state is consistent with, for example, containers having goods therein that are in transit or in storage. The locking mechanisms 250, 260 have a “three-phase” operation, where the phase depicted in FIGS. 10A and 10B are the first phase. Now the first locking mechanism 250 and its operation will be described, with the understanding that the second locking mechanism 260 is configured substantially similarly.

The first locking mechanism 250 has two lock handles 251 pivotably disposed on the first door 232 on a pivot connection 258. Each lock handle 251 is connected to an upper lock rod 255 extending upwards that is configured to engage the top of the door frame 220 and the container (not shown). Each lock handle 251 is also coupled to a lower lock rod 256 extending downwards that is configured to engage the bottom of the door frame 220 and the container (not shown). The first locking mechanism 250 can be constructed of a variety of materials and combinations of materials, and it will be appreciated that such materials can be determined by those of ordinary skill in the art. In one embodiment, components of the first locking mechanism 250 are constructed of steel and steel alloys or composite material.

Each lock handle 251 can have a variety of shapes and sizes, and as depicted in the current Figures is an elongated member defining a central void 252 by which the lock handle 251 is pivotably coupled to the door structure 230 through a pivot connection 258. The pivot connection 258 can have a variety of configurations as will generally be known in the art. When in this first phase of operation, the lock handle 251 is in a substantially horizontal position, and in various embodiments can be manually positioned as such.

FIG. 10C is a front view of a lock handle 251 which includes two slip holes 257. The proximal end of the upper lock rod is pivotably coupled to the lock handle 251 through the slip hole 257 defined by the first end of the lock handle 251. The distal end of the upper lock rod 255 is received by the top of the door frame 220 and the top of the container (not shown). The proximal end of the lower lock rod 256 is pivotably coupled to the lock handle 251 through a slip hole 257 defined by the second end of the lock handle 251, and extends downwards. The distal end of the lower lock rod 256 is received by the bottom of the door frame 220 and the bottom of the container (not shown).

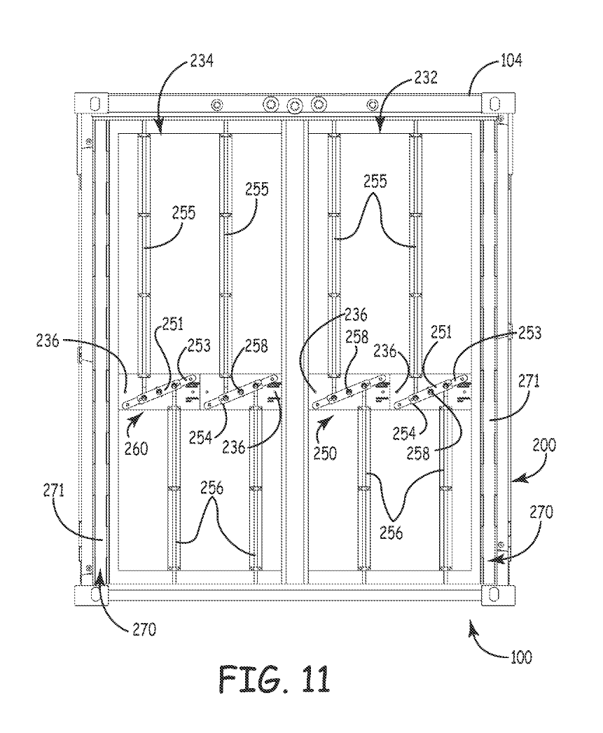

As is depicted in FIGS. 11-14 and will be further described below, the locking mechanisms 250, 260 are engaged and disengaged by pivoting the lock handle 251 about the central void 252, which not only translates the upper lock rod 255 and lower lock rod 256 to an alternate position, but pivots the proximal ends of the upper lock rod 255 and lower lock rod 256. The slip holes 257 defined by the lock handle 251 are long enough to allow the proximal ends of the lock rods 255, 256 to shift position along the length of the slip hole 257 to compensate for stress applied to the lock rods 255, 256 in response to pivoting of the proximal end of the upper lock rod 255 and lower lock rod 256. As such, the slip hole can have a length that is consistent with a substantially perpendicular upper lock rod 255 and lower lock rod 256, regardless of the pivot of the locking handle 251. In the current embodiment the slip holes 257 are about 1⅛ inches long with each end having a radius of about ¼ inch.

Referring to FIGS. 10A and 10B, a padlock extension 253 is coupled to each side of the lock handle 251 along a hinge 254. The padlock extensions 253 are generally configured to receive a lock such a padlock, which prevents pivoting of the lock handle 251. The padlock extensions 253 define an opening that receives a nodule 236 on the door structure 230 when the lock handle 251 is in the first phase of operation. In one embodiment the nodule 236 is configured to receive a padlock. When operating the first locking mechanism 250 to a second or third phase, the padlock is removed and the padlock extensions are pivoted away from the container door 200, which releases the nodules 236.

Now the rest of the components of the container door 200 will be described. The door frame 220 can be constructed of a variety of materials, and in various embodiments will be constructed of substantially similar materials as those of the skeletal structure 104 such as steel, steel alloys, and/or composite material. The door frame 220 is generally rectangular in shape and defines a central opening that is configured to receive the door structure 230. The door frame 220 is also configured to be coupled to the perimeter of the aperture of at least one end of the container.

### Container Door Structure

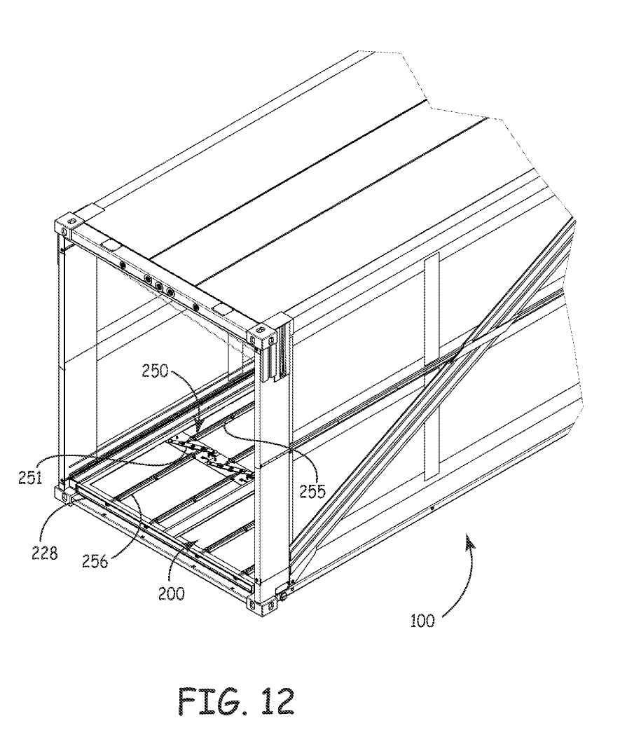

With reference to FIGS. 10A, 10B, 11 and 12, the perimeter of the aperture is defined by the skeletal structure 104 of the container 100, in one embodiment (see the description of FIGS. 1-4, above). In another embodiment the perimeter of the aperture is defined by the outer edges of the panels. The door frame 220 can be coupled to the skeletal structure 104, panels, or the like, through a variety of means that will be known in the art. In one embodiment the door frame 220 is coupled to a substantial length of the material defining the bottom edge of the aperture with a bottom hinge 228 (FIG. 12) that allows folding and/or pivoting, of the door frame 220 into the container 100. In at least one embodiment the hinge is spring-loaded to assist in folding the door frame 220 into the container. As mentioned above, an end panel and/or the door 110 can be configured to fold into the container 100 along the top edge of the container 100 in an embodiment.

The door frame 220 defines frame-lock openings 222 for receipt of the distal ends of the first locking mechanism 250 and the distal ends of the second locking mechanism 260. Such frame-lock openings 222 are substantially aligned with lock openings defined by the container 100 such that each frame lock opening 222 and a corresponding opening defined by the container 100 form a passageway that receives the distal end of the first locking mechanism 250 or the distal end of the second locking mechanism 260. The door frame 220 is further configured to receive at least the first door 232 and the second door 234 of the door structure 230.

The line of contact between the door frame 220 and the door structure 230 can be configured as a tortuous path to prevent water from entering the container when the container is in an upright position and the first door 232 and second door 234 are closed. In multiple embodiments the door frame 220 defines a step along the interior bottom surface that at least partially contacts the door structure 230. In an embodiment, a substantially perpendicular surface of the step partially contacts the bottom of the door structure 230 when the first door 232 and second door 234 are closed.

The door structure 230 includes the first door 232 and the second door 234, although in a variety of embodiments a single door can be used. Double-hinges 270 (FIGS. 10B, 13 and 14) are used to couple the first and second doors 232, 234 to the door frame 220 along at least a portion of the length of each side of the door frame 220. The double-hinge 270 is configured to allow the doors 232, 234 to open outwardly to about 270 degrees relative to their closed positions. The double-hinge 270 is constructed of an elongated member 272 extending at least a portion of the height of the door structure 230. A first hinge 274 is disposed along a portion of the length on one side of the elongated member 272, and a second hinge 276 is disposed along a portion of the length of the opposite side of the elongated member 272. The door frame 220 is coupled to the first hinge 274 and the first door 232 is coupled to the second hinge 276.

Referring to FIG. 10B, door panels 210, 212 are coupled to the first door 232 and second door 234, respectively. The door panels 210, 212 are configured to prevent access to the inside of the container from the outside of the container. A first door panel 210 is mounted on the first door 232 and a second door panel 212 is mounted on the second door 234. In one embodiment each door panel 210, 212 measures 103⅜ inches high by 45¼ inches wide by 1 inch thick.

The door panels 210, 212 can be substantially similar to the panels discussed in the discussion of FIG. 1, above. The door panels 210, 212 can be a variety of materials and combinations of materials, but in at least one embodiment is at least partially composed of composite material. In such an embodiment the composite material can have a corrugated structure, and are generally rectangular in shape. In such embodiments the door panels 210, 212 can also be constructed of foam, a variety of plastics, and the like. In one embodiment the composite material sandwiches a plastic material. In one other embodiment composite material sandwiches a foam material that is sprayed on the composite material, where air between the layers of composite material and the foam is vacuumed out for increased strength. In yet another embodiment, the door panels 210, 212 are constructed of a composite material honeycomb structure, where expanding foam is used to fill the voids defined by such honeycomb structure. In various embodiments the door panels 210, 212 are permeable to some forms of electromagnetic radiation such as X-radiation (X-rays).

Each door panel 210, 212 defines one or more rod passages 211 that are configured to receive one or more sheer support rods 240. Each door panel also defines one or more end cap notches 214 that are configured to accommodate end caps 242 that are coupled to the each end of each support rod 240. The rod passages 211 are defined diagonally relative to the substantially rectangular door panels 210, 212. In one embodiment the door panels 210, 212 are each about one inch thick. In such an embodiment each door panel 210, 212 defines rod passages 211 across alternative diagonals relative to the door panel 210, 212. Such rod passages 211 are defined so that they do not substantially intersect within the door panel 210, 212. For example, in the embodiment depicted in the current figures, one rod passage 211 is defined 3/16 inch away from the front surface of the first door panel 210, and another rod passage 211 is defined 3/16-inch away from the front surface of the first door panel 210. Different dimensions can be used depending on the materials used or other factors.

FIG. 10D is a close-up view of the end cap of one of the sheer support rods 240. The end caps 242 of the sheer support rods 240 are configured to mate with the door structure 230, where the door structure 230 defines end-cap mating surfaces . The end-cap mating surfaces and the corresponding end caps 242 can mate through a variety of mechanisms such as female and corresponding male components, fastening mechanisms such as bolts , welds, or composites, or through any other means known in the art. In alternative embodiments the door panels 210, 212 can be coupled to the door structure 203 through other means, as well.

In the current embodiment the end caps generally are configured similarly, and one will be described for further understanding. A portion of the end cap 242, from a first end 243, defines an opening 245 that is configured to receive a portion of the sheer support rod 240. In the current embodiment the opening 245 has a substantially circular cross section that has a diameter of about ⅝ inch. A rim (not shown) defined by the end cap 242 within the opening 245 defines an smaller opening of about ¼-inch at a particular depth within the end cap 242 that allows passage of the sheer support rod 240 there through. Such rim prevents progression of the sheer support rod 240 through the entire end cap 242. In another embodiment the opening defined by the rim is approximately ⅝-inch.

A second end 244 of the end cap 242 is configured to mate with the door structure 230 and has a flange 246 the approximate thickness of the door panel 210, 212. The flange 246 is configured at an angle such that a plane substantially defined by the outside surface of the flange 246 substantially aligns with a plane substantially defined by the door structure which can be referred to as an end cap mating surface (not depicted)of the door structure 230. The end cap 242 can be coupled to the door structure 230 through a variety of means known in the art such as, for example, nuts and/or bolts. In another embodiment the door structure 230 can couple to the sheer support rod 240, also through means generally known in the art.

In one embodiment the sheer support rods 240 have a circular cross-section and measure ¼ inch in diameter by 9 feet long, although alternatively-shaped cross-sections are also contemplated. Another embodiment has a diameter of approximately 3/16-inch. Again, different dimensions can be used depending on the materials used or other factors.

A portion of each end of the sheer support rods 240 can be threaded such that upon passage of the sheer support rod 240 through the opening defined by the internal rim of the end cap 242, a nut can be threaded onto the sheer support rod 240 from the other side of the rim to prevent at least one direction of movement of the sheer support rod 240 relative to the end cap 242. In another embodiment a nut can be threaded on the sheer support rod 240 on each side of the internal rim of the end cap 242 to prevent two directions of movement of the sheer support rod 240 relative to the end cap. The sheer support rods 240 can be constructed of steel, for example, although other materials generally used in the art are contemplated. The end caps 242 can likewise be constructed of steel, although other materials in the art can be used, such as other metals and plastics.

### Container Door Locking System Phases

The container door locking system has three different phases or positions. Phase one of the locking process is employed to hold items and transport the container, and is illustrated in FIG. 10A, where the lock handles 251 are in a horizontal orientation. The discussion of FIGS. 11-14 below is relevant to phase two and phase three of the three-phase container door locking system. Phase two of the locking system is employed to prepare the container 100 for collapse and during the collapsing process. Phase three of the locking process is employed to open the container door for loading or unloading and allows the first door 232 and second door 234 to be opened. Those of skill in the art will recognize that the door locking system can be applied to a variety of different structures not limited to a shipping container or any other container.

FIG. 11 is a front view of a closed container door 200 with the locking system in phase two and FIG. 12 is a perspective view of a folded-down container door with the locking system in phase two. The lock handle 251 is generally pivotably disposed on the door. In phase two of the locking system, the lock handle 251 is configured to have a second position, where the lock handle 251 is pivoted to approximately 22.5 degrees relative to the substantially horizontal position of the lock handle 251 such that the upper lock rod 255 is shifted downward and the lower lock rod 256 is shifted upward. In one embodiment the second position of the lock handle 251 can range from 20-30 degrees relative to its substantially horizontal position. This disengages upper lock rod 255 from the top of the container 100 and the lower lock rod 256 from the bottom of the container, while the door frame 220 remains engaged by the locking mechanism 250. Such a phase allows the container door 200 and door frame 220 to be folded along the bottom hinge 228 to the bottom of the container 100 in one piece. In at least one embodiment the bottom hinge 228 can be spring-loaded to provide sufficient force to the container door 200 and door frame 220 such that they collapse automatically upon engagement of phase two of the locking system and the release of the cables supporting the end wall, which will be described below.

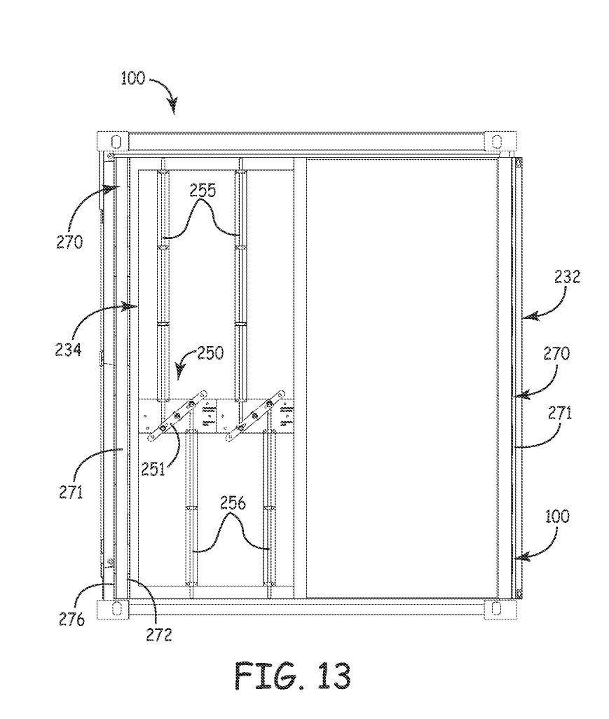

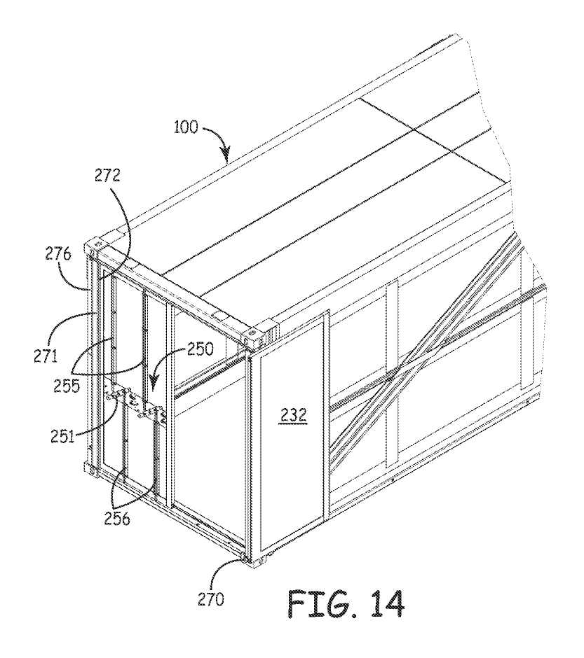

FIG. 13 and FIG. 14 illustrate phase three of the three-phase locking system. FIG. 13 is a front view of the door unlocked with one side open and FIG. 14 is a perspective view of the door unlocked with one side open. In embodiments where an end wall is not a container door, a third locking phase may not be necessary and may be foregone. Phase three of the locking system is employed when the container 100 is being loaded and/or unloaded with goods. In phase three, the lock handle 251 is configured to have a third position. The lock handle 251 is turned to an about 40 degree angle or more relative to the horizontal position of the lock handle 251. In a variety of embodiments the third position of the lock handle 251 can range from about 35 degrees to about 60 degrees relative to its substantially horizontal position. The upper lock rod 255 disengages from both the top of the container 100 and the top of the door frame 220, and the lower lock rod 256 disengages from both the bottom of the container 100 and the bottom of the door frame 220, at which point the locking mechanism 250 is no longer preventing the first door 232 and second door 234 from being opened or pivoted with respect to the door frame 220.

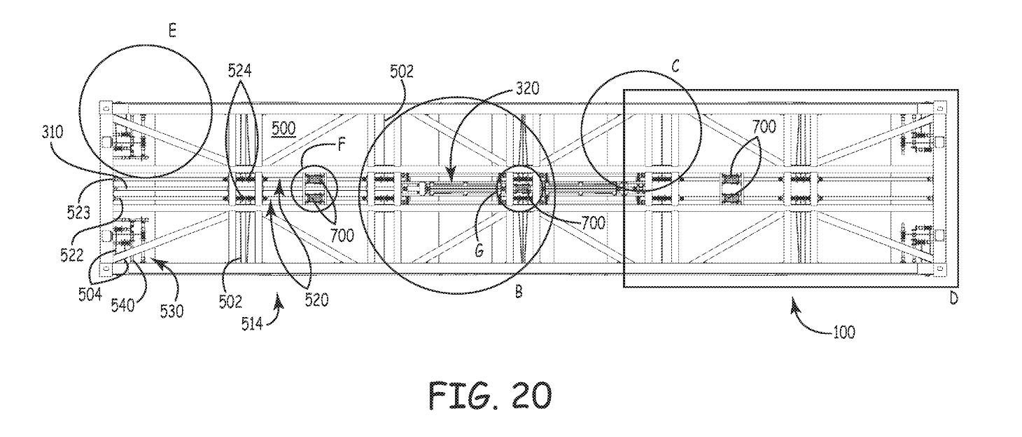

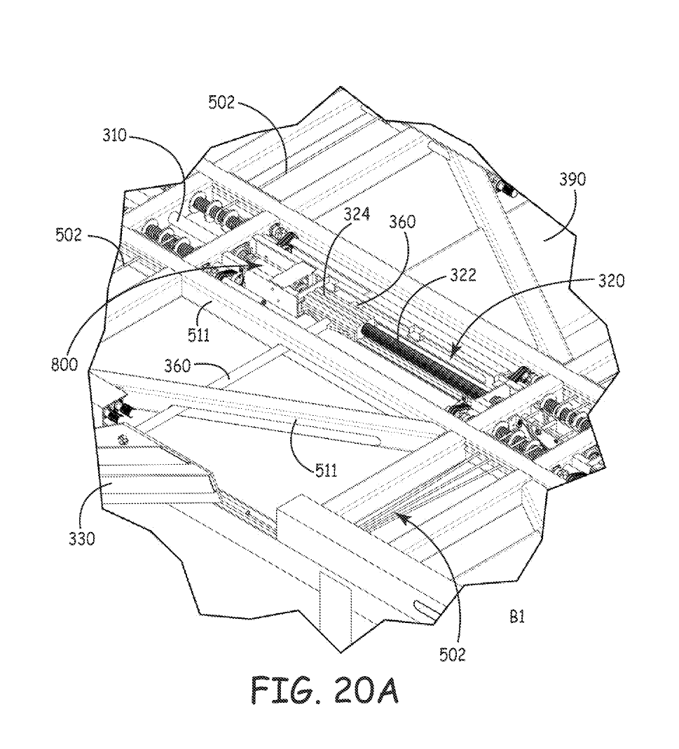

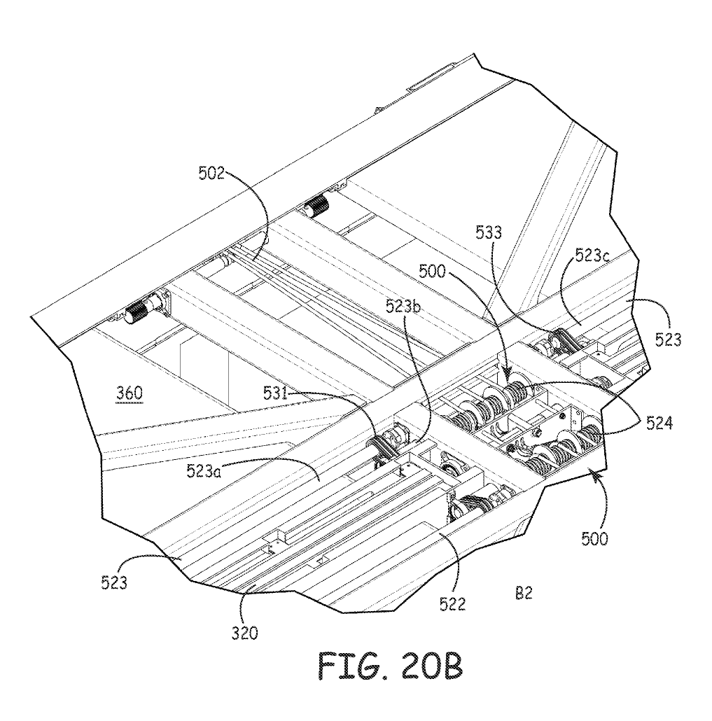

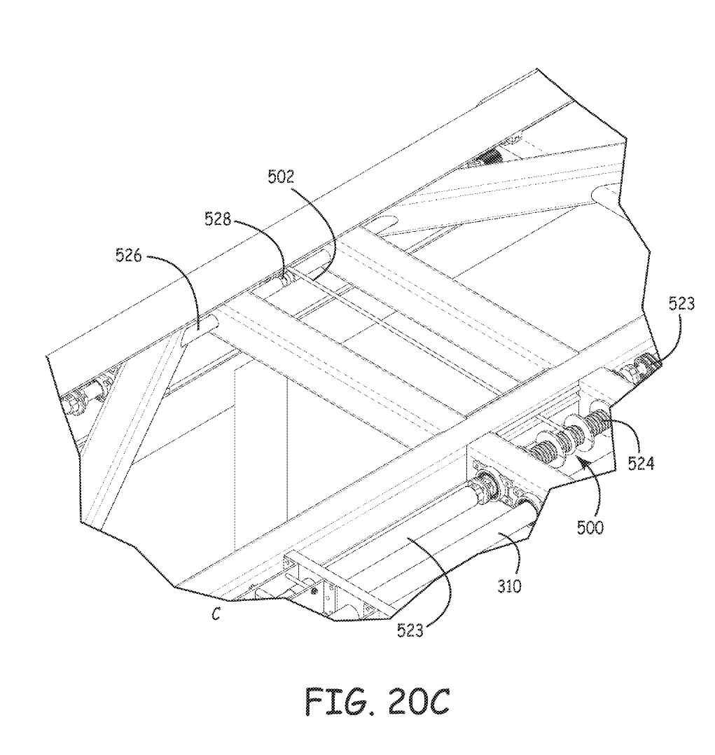

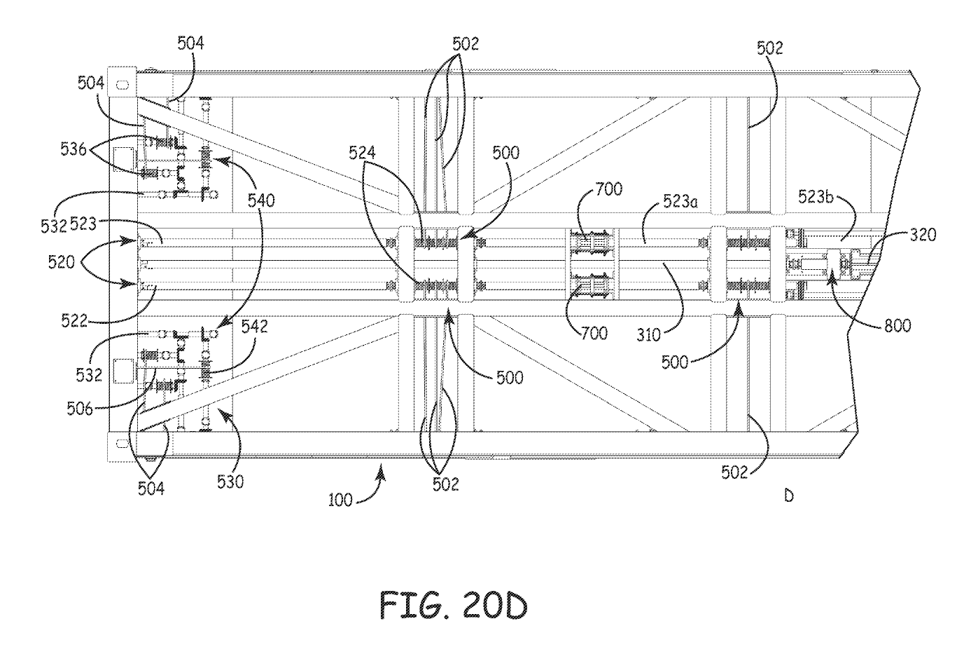

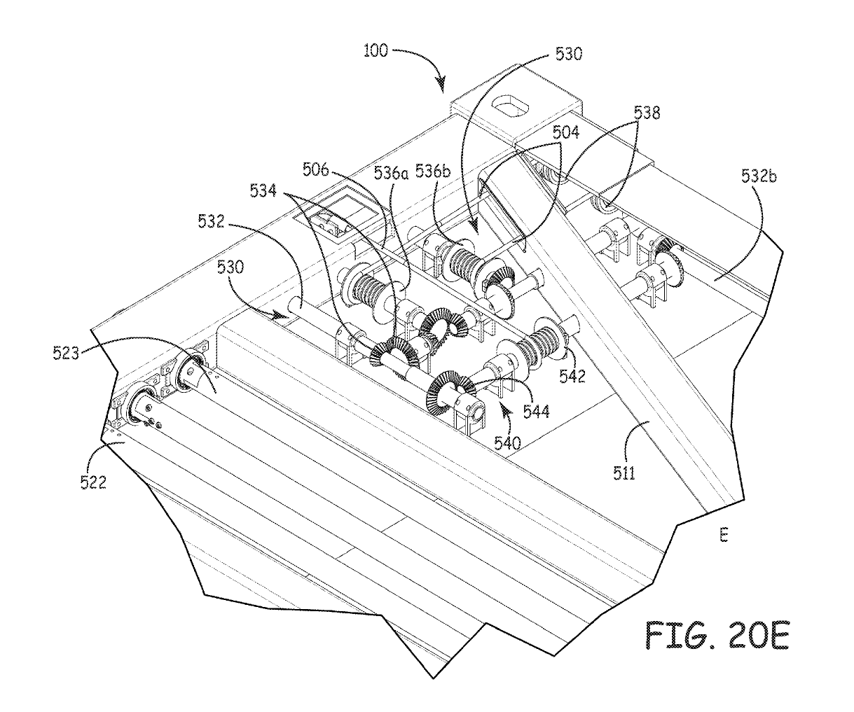

An end wall cable system that will be explained in the description of FIGS. 20, 20D 20E, below, consists of end wall cables that keep a container door erect in phase three of the three-phase locking system. The end wall cables couple to the top of the end wall and to the top of the container, and are under tension to prevent collapse of the container door.

### Seal Between the Door and the Container

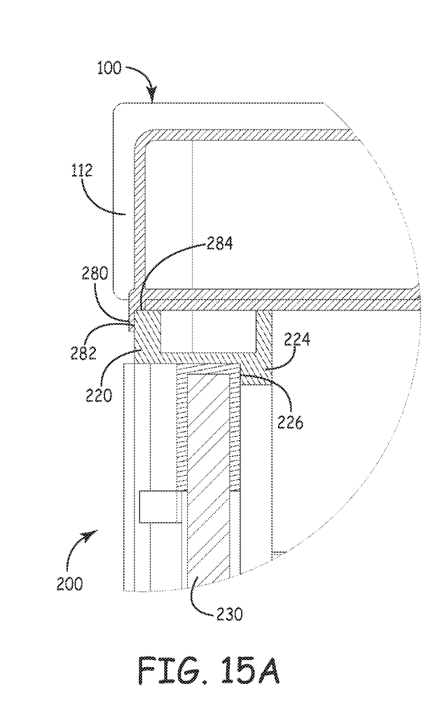

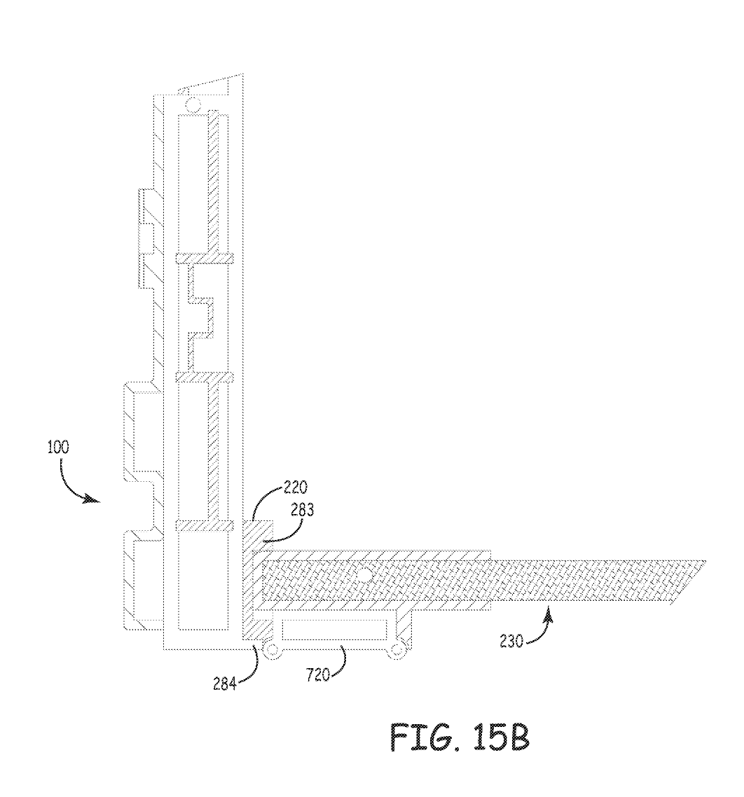

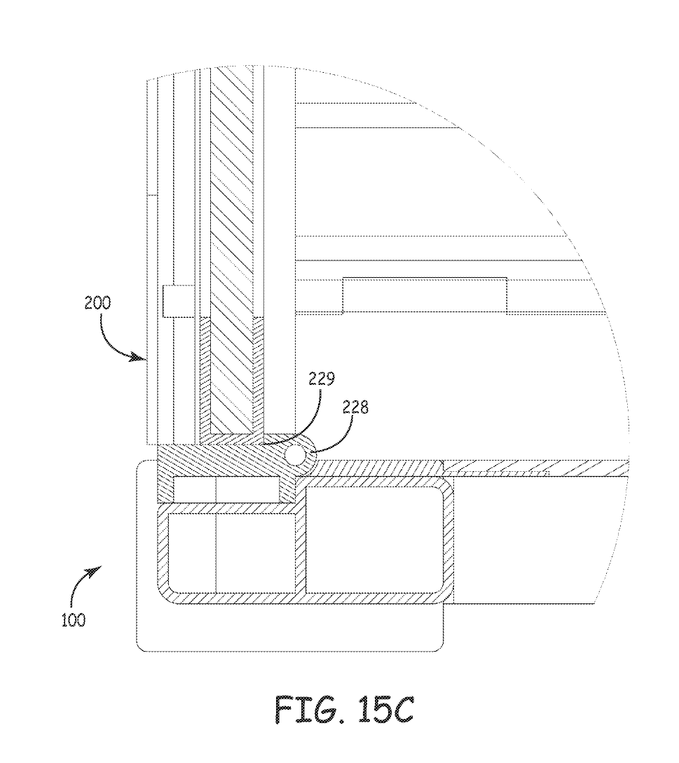

FIG. 15A is a cross-sectional view showing the door closed against the container top, and FIG. 15B is a cross-section view showing the door closed against the container side. FIG. 15C is a cross-section view depicting the door closed against the container bottom, through a hinge along the base of the door. As mentioned in the discussion of FIG. 10A and FIG. 10B, above, the contacts among the container 100, the door frame 220, and the door structure 230 can be configured to deter or prevent water from entering the container when the container is in an upright position and the first and second doors are closed.

In FIG. 15A, the door frame 220 defines a step 224 along the interior bottom surface of the top member of the door frame 220 that at least partially contacts the door structure 230. The substantially perpendicular surface 226 of the step 224 partially contacts the top of the door structure 230 when the first door and second door are closed. Such a structure establishes a tortuous path that water would have to follow to enter the container, and the intention is that the tortuous nature of the path prevents entry of water to the container. Additionally, the bottom side of the container top 112 that defines the top portion of the door aperture has a top lip 280 that has a perpendicular 282 and horizontal surface 284 that is configured to at least partially contact the door frame 220 to deter entry of water into the container from the top of the container door 200.

In FIG. 15B, a longitudinal side of the container has a side lip 284 that at least partially contacts the door frame 220 to deter entry of water into the container from the sides of the container door 200. Additionally, the door frame defines a second step 283 that creates a tortuous pathway to deter entry of water into the container.

Additionally, FIG. 15C demonstrates an additional container structure that forms a tortuous path that prevents entry of water. As mentioned above in the discussion of FIG. 12, the bottom hinge 228 is coupled to the door 200 so as to allow folding of the door 200 down to the bottom surface of the container in preparation for collapsing the container 100. The bottom hinge 228 defines a hinge step 229 that the door 200 and door frame are coupled to such that they at least partially contact the horizontal and perpendicular surfaces of the hinge step 229. In an embodiment where the top edge has a hinge, the bottom edge would still define a step such to prevent entry of water to the container 100, for example.

Structures forming the seals between components of the container 100 and container door 200 could additionally be coated with, or generally include, a partially compressible material such as silicone or rubber that would further prevent entry of water. Other materials could also be used.

As discussed above, the container doors 200 are collapsed prior to collapsing the rest of the container 100. Now mechanisms associated with collapsing and expanding the container will be described. FIG. 16 is relevant to a collapsing mechanism that is used for directly collapsing and expanding the container. FIGS. 17-19 are relevant to a joint support system incorporated in the container to provide support to hinges of the container when the container is erect. FIGS. 20-23 are relevant to a tensioning mechanism that is used for providing tension within the longitudinal sides when the container is expanded, and removing tension within the longitudinal sides when the container is collapsed.

### Screw System

FIG. 16 is a perspective view of a collapsing mechanism separated from the remainder of the container. As will be described below, two such collapsing mechanisms 300 are generally employed on a container, one employed in communication with the front of the container, and one employed in communication with the back of the container. Referring to FIG. 20, the back of the container refers to the end of the container within detail D, and the front of the container refers to the end of the container partially within detail E. The collapsing mechanism 300 shown in FIG. 16 is employed on the front of the container, which includes the screw system depicted in Detail B of FIG. 20 (item 300).

The collapsing mechanism 300 has a drive shaft (not shown in FIG. 16) is in mechanical communication with a screw system 320 that is in further mechanical communication with the top ends of front lift beams 330 that are slidably disposed along a portion of the top of the container. A top portion of a screw system housing 328 is removed such that the screw system 320 components are viewable. FIG. 20A depicts the screw system 320 on a container, as well, with the screw system housing and a portion of the container removed for clarity.

A screw 322 of the screw system 320 is coupled to a drive shaft that rotates the screw 322 about a central axis 326. The screw receptacle 324 of the screw system 320 is coupled to two lift beams 330 in the front of the shipping container. As the screw 322 is rotated, the screw receptacle 324 laterally translates along the screw 322, which laterally translates the portion of the front lift beams 330 coupled to the screw receptacle 324. Although, as depicted in FIG. 16, only the two front lift beams 330 are shown, it should be understood that the back of the container likewise has a screw system 320 coupled to two back lift beams.

The screw system 320 is coupled to the lift beams 330 such that progression of the screw receptacle 324 along the screw 322 of the screw system 320 collapses the container, and regression of the screw receptacle 324 along the screw 322 expands the container. The coupling and interaction of the screw system 320 relative to the lift beams 330 is described now in terms of the lift beams 330 that are visible in FIG. 16. The lift beams generally stabilize the container to collapse and expand in a substantially vertical motion, without side-to-side movement.

As the screw receptacle 324 progresses, sliding connectors 360 laterally translate along slots defined by the screw gear housing 328, sliding sheaths 390 and a sliding slot defined by the container. As such, the second ends 332 of the front lift beams 330 laterally translate towards the center of the container, causing the front lift beams 330 to pivot downwardly in a clockwise manner, about their respective first ends as described in the discussion of FIGS. 1-5. Accordingly, the second ends of the back lift beams also pivot downwardly, but in a counterclockwise manner, about their first ends as described in the discussion of FIGS. 1-5. As the front lift beams 330 and back lift beams slide closer together along their corresponding sliding slots and pivot about their respective pivot connections, each beam exerts a downward force on the container within each corresponding sliding slot. The downward force exerted by the lift beams 330 guides the hinged components of the container to collapse and fold about their respective hinges as depicted in FIGS. 3-4.

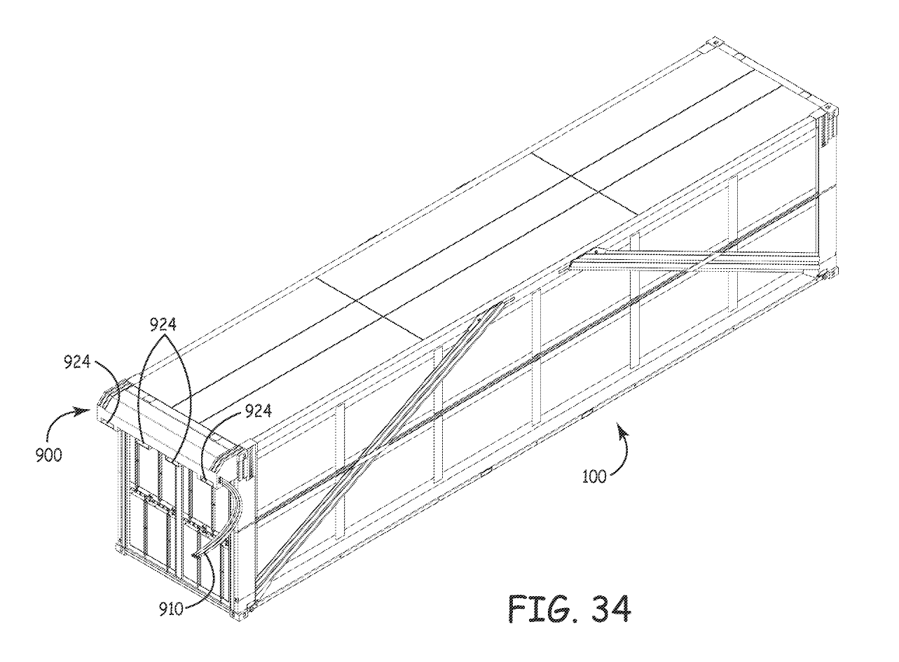

As the screw system 320 regresses, on the other hand, the second ends 332 of the front lift beams 330 slides along their respective sliding slots away from the center of the container, causing the first lift beams 330 to pivot upwardly in a counterclockwise manner about their first ends. The second ends of the back lift beams slide along their respective sliding slots away from the center of the container to pivot upwardly, but in a clockwise manner, about their first ends. As the front lift beams 330 and back lift beams slide away from each other along their corresponding sliding slots and pivot about their respective pivot connections, each lift beam exerts an upward force on the container within each corresponding sliding slot. The upward force exerted by the lift beams guides the hinged components of the container to unfold about their respective hinges and expand. Although not depicted in FIG. 16, the drive shaft is depicted in FIG. 20A and is generally responsible for providing the mechanical forces necessary to expand and collapse a container. FIG. 20A is a perspective view of detail B in FIG. 20 that depicts the drive shaft. The drive shaft 310 is coupled to the screw system 320 and transmits rotational motion thereto. In multiple embodiments the drive shaft 310 is directly coupled to the screw 322 of the screw system 320. As will be explained in the discussion of FIG. 34 below, the drive shaft 310 is also in mechanical communication with a power take-off device (not shown). The drive shaft 310 is constructed of steel, steel alloy, aluminum, or a composite such as fiberglass or carbon fiber in various embodiments, although other materials are contemplated as well.

Referring to FIGS. 16 and 20A, the two sides of the screw receptacle 324 are mechanically coupled to the lift beams 330 on each side of the container with sliding connectors 360 that are slidably disposed through the screw system housing 328, a sliding sheath 390, and sliding slots defined by the container (but not depicted in the current Figures). A portion of the sliding sheath 390 is cut away in FIG. 16 for viewing of one sliding connector 360, although there is a second sliding connector 360 extending from the opposite side of the screw receptacle 324 within another sliding sheath 360. One sliding sheath 360 is completely removed from FIG. 20A.

The screw receptacle of each screw system is configured to have substantially equal horizontal displacement in response to the drive shaft as each screw system is progressed or regressed. A screw receptacle in the front of the container can have threading the runs counter to the screw receptacle in the back of the container such that a shared drive shaft can elicit opposite linear displacement of the screw receptacles relative to the container. In various embodiments the screw 322 of each screw system 320 is mechanically coupled to the drive gear and share an axis 326 of rotation with the drive gear. The screw systems 320 can be substantially symmetrical with respect to a central portion of the container.

In this particular embodiment, the second end 332 of each of the lift beams 330 slidably engages the container through a corresponding sliding slot, such that horizontal translation of the second end 332 is restricted to be the length of the sliding slot. An opening 334 defined by each of the lift beams 330 receives a sliding connector 360 that is configured to slide along the sliding slot defined by the container. The opening 334 of the lift beam 330 also accommodates rotation of the second end 332 of the lift beam 330 relative to the sliding connector 360 upon linear translation of the lift beam along the sliding slot. Other configurations of the lift beams 330 are also possible within the scope of the technology disclosed herein. For example, the container could define a track where the second ends 332 of the lift beams 330 engage the track in a slidable manner.

The four lift beams 330 are substantially similar in size, shape, and interaction with the container, except for hinge channels 336 (FIG. 16) defined by each of the lift beams 330 that are configured to accommodate their respective hinges on the container when the container is in an expanded position. The lift beams on the right side of the container are substantially symmetrical to the lift beams on the left side of the container. The lift beams 330 on the front of the container are substantially symmetrical to the lift beams on the back of the container. The lift beams 330 are constructed of steel, a steel alloy, and/or a composite material in various embodiments, although other materials are contemplated as well.

The sliding connectors 360 are elongated rods, tubes having a square cross section, members, or the like, that each extend from the screw receptacle 324 of the screw system 320 to each respective front lift beam 330. In various embodiments a connector axis 325 mutually defined by the sliding connectors 360 is substantially perpendicular to a substantially central axis 326 defined by the screw system 320 and the connector axis 325 of the sliding connectors 360 are substantially perpendicular to a first plane 370 substantially parallel to planes defined by the front lift beams 330.

The sliding connectors 360 can have a circular cross section in multiple embodiments, although it is not necessary for practicing the technology disclosed herein. In some embodiments the sliding connectors 360 are directly received by the openings 334 defined by each of the front lift beams 330. Coupling of the sliding connectors 360 to the front lift beams 330 can be though any means known in the art. The sliding connectors 360 can be constructed of steel or a steel alloy in various embodiments, although other materials are contemplated as well.

### Screw System of an Alternative Embodiment

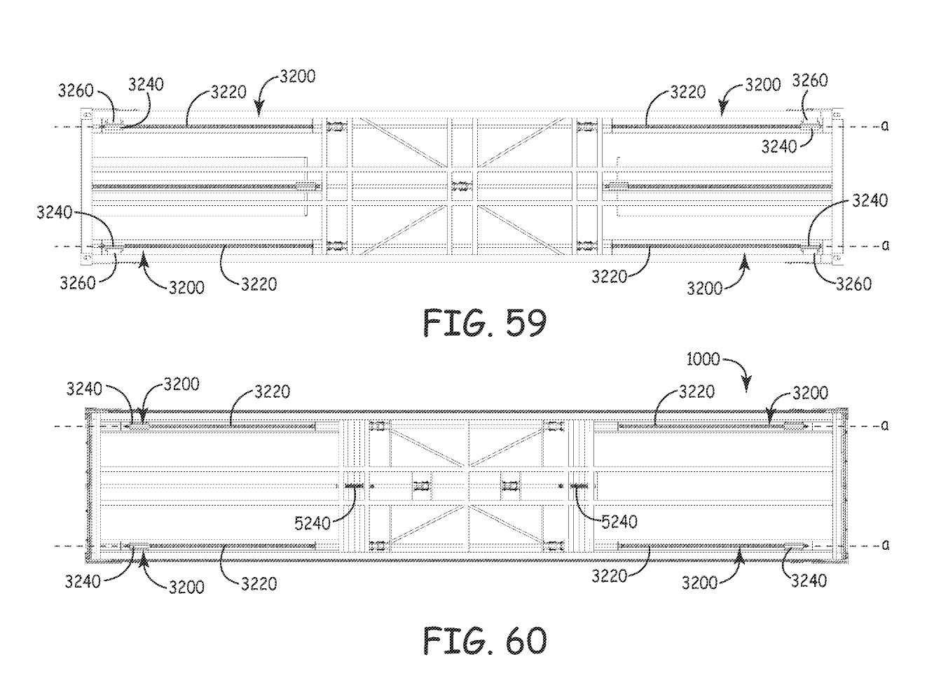

FIG. 58 is a perspective view of the container 1000, revealing the portion of the collapsing mechanism on the top of the container 1000 similar to the alternative embodiment depicted, for example, in FIG. 39. FIG. 59 is a top view of the container 1000 also depicting the portion of the collapsing mechanism on the top of the container. FIG. 60 is a bottom view of the container, depicting the portion of the collapsing mechanism on the bottom of the container. In all of these Figures a top portion of a screw system housing is removed such that the screw system components are viewable. The collapsing mechanism employs screw assemblies similar to the embodiment depicted in FIGS. 16 and 20. Four screw assemblies 3200 are on the top of the container 1000, and four screw assemblies 3200 are on the bottom of the container 1000. However, other configurations can be used within the scope of the technology disclosed herein.

Similar to the previously-described embodiment, the collapsing mechanism has a drive shaft in mechanical communication with a screw system that is in further mechanical communication with the ends of lift beams that are slidably disposed along a portion of the container 1000. Each screw 3220 of the screw system is coupled to a drive shaft that rotates the screw 3220 about a central axis α (See FIGS. 59 and 60). Instead of being coupled to two lifts beams, as in the previous embodiment, the screw receptacle 3240 of each screw system is coupled to one lift beam of the container 1000. As the screw 3220 is rotated, the screw receptacle 3240 laterally translates along the screw 3220, which laterally translates the portion of the lift beam coupled to the screw receptacle 3240. On the top of the container 1000 of the alternative embodiment, each screw receptacle 3240 is coupled to the second end 1520 of the primary lift beam 1500. Likewise, on the bottom of the container 1000, each screw receptacle 3240 is coupled to the second end 1620 of the secondary lift beam 1600.

As each screw receptacle 3240 progresses, sliding connectors 3260 laterally translate along a sliding slot 1050, 1060 defined by the container, similar to the embodiment of FIG. 16. The second ends 1520 of the primary lift beams 1500 laterally translate towards the center of the container 1000, causing the primary lift beams 1500 to pivot downwardly towards the center of the container 1000, about their respective first ends 1510. Further, the second ends 1620 of the secondary lift beams 1600 also laterally translate towards the center of the container 1000, causing the first ends 1610 of the secondary lift beams 1600 to pivot downwardly away from the center of the container 1000. As the support provided by the lift beams 1500, 1600 shift, the components of the container 1000 release in response to gravity and proceed to fold about their respective hinges 1300, to the extent allowed by the lift beams 1500, 1600.

As the screw system regresses, on the other hand, the second ends 1520 of the primary lift beams 1500 slides along their respective sliding slots 1060 away from the center of the container 1000, causing the primary lift beams 1500 to pivot upwardly, which exerts an upward force on the sliding slots 1060 defined by the container 1000. The second ends 1620 of the secondary lift beams 1600 also slide away from the center of the container 1000, causing the secondary lift beams 1600 to also pivot upwardly, which exerts an upward force on the primary lift beam 1500 at the pivot point 1630. As such, each lift beam 1500, 1600 exerts an upward force either directly or indirectly on the container 1000 to guide the hinged components of the container 1000 to unfold about their respective hinges 1300 and expand.

When the container 1000 is collapsed the primary lift beams 1500 remain in a partially angled position relative to the horizontal plane. The discussion associated with FIGS. 62 and 63 explains how the primary lift beams 1500 pivot to be substantially horizontal after the container 1000 is collapsed, and lock into place.

### Joint Plates

A support mechanism is incorporated into the container to provide structural support to the joints defined by the jointed columns when the container is in an expanded position. FIG. 17 is a cut-away view of a column with a joint plate in a first position. FIG. 18 is a cut-away view of a column with a joint plate in a second position. The joint plate 420 is configured to slide over a joint 412 to provide joint support when the container is expanded and, therefore, the column 105 is expanded. The joint plate 420 is further configured to slide away from the joint 412 when the container is collapsed and, therefore, the column 105 is folded. In one embodiment the joint plate 420 is disposed on joint cable 430, and when the joint cable 430 are tensioned each joint plate 420 slides into position over a corresponding joint 412. As will be described in the description of FIG. 20, translation of the joint cable 430 and the joint plate 420 is determined by a drive shaft in mechanical communication with the joint cable 430.

The joint cable 430 can be constructed of a variety of materials, and in various embodiments are constructed of steel and/or a synthetic material. Other materials and combinations of materials are contemplated that would be workable within the assembly.

The column 105 defines cavities that are configured to accommodate the vertical translation of the joint plate 420 and the joint cable 430. In the example embodiment depicted in FIG. 17, the column 105 defines a joint plate pathway 450 below the hinge 412 to accommodate translation of the joint plate 420 below the hinge 412 when the column 105 is folded about the hinge 412 such as when a container is collapsed. Pulleys 440 are additionally disposed within a cavity defined by the column 105 where the pulleys 440 provide a translation pathway for the joint cable 430. In the example embodiments depicted in FIGS. 17 and 18 six smaller pulleys 440 define a pathway for the cable at the bottom of the column. It is also possible for more or less pulleys and pulleys of different sizes to be incorporated in the column 105.

Each column within a container can have a joint plate disposed thereon. In at least one embodiment, each hinge of each column of the container has one joint plate associated therewith. In a variety of embodiments, some joint plates can be translated above the hinge when a container is collapsed and some joint plates can translate to a position below the hinge when a container is collapsed.

Referring to FIG. 5, an end view of the collapsed container is shown, where there is a collapsed column 105 on the first longitudinal side 116 and a collapsed column 105 on the second longitudinal side 118. Because of the hinge locations, the joint plates of the column on the first longitudinal side 116 slide down to allow the column to collapse. The joint plates of the column of the second longitudinal side 118 slide up to allow the column to collapse.

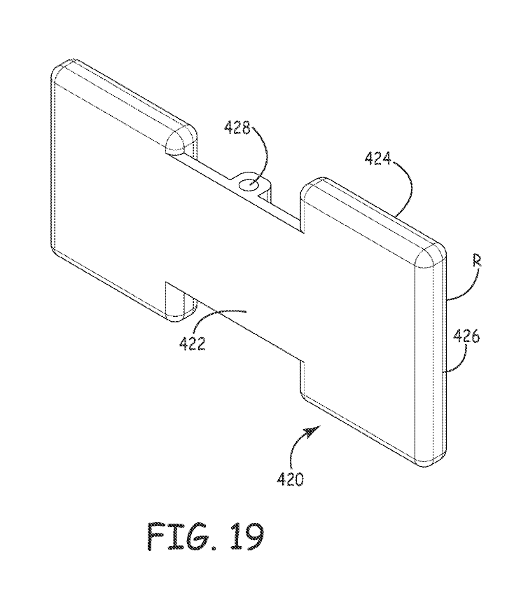

FIG. 19 is a perspective view of the joint plate depicted in FIG. 17 and FIG. 18. The joint plate 420 is generally configured to be slidably disposed within a column, such as depicted in FIGS. 17 and 18 described above. The joint plate 420 can be constructed of a variety of materials in a variety of configurations, and in the current embodiment is a solid piece of steel, solid piece of composite material, or shaped composite material such as a honeycomb shape or corrugated shape. In one embodiment, the joint plate is coated with a low-friction material such as a grease, plastic, or Teflon material to make it easier for the joint plate to slide between different positions. The joint plate 420 has a shape that allows the column to accommodate the joint plate 420 in a vertical orientation.

The joint plate 420 has a first major surface 422 and a second major surface 424 that is substantially parallel to the first major surface 422. An edge surface 426 is defined between the first major surface 422 and the second major surface, where at least a portion of the edge surface 426 is substantially perpendicular to the first major surface 422 and second major surface 424. At least a portion of a length of the edge surface 426 has a radius R. In various embodiments the joint plate 420 is constructed of a portion of solid steel, steel alloy, and/or composite material, having a structure that is corrugated or honeycomb shaped, although it will be appreciated by those skilled in the art that other materials would also be appropriate for the joint plate 420.

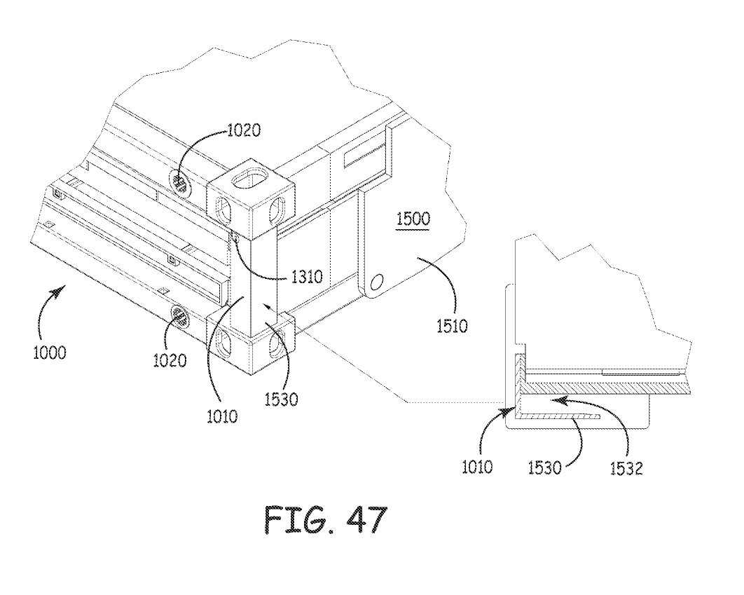

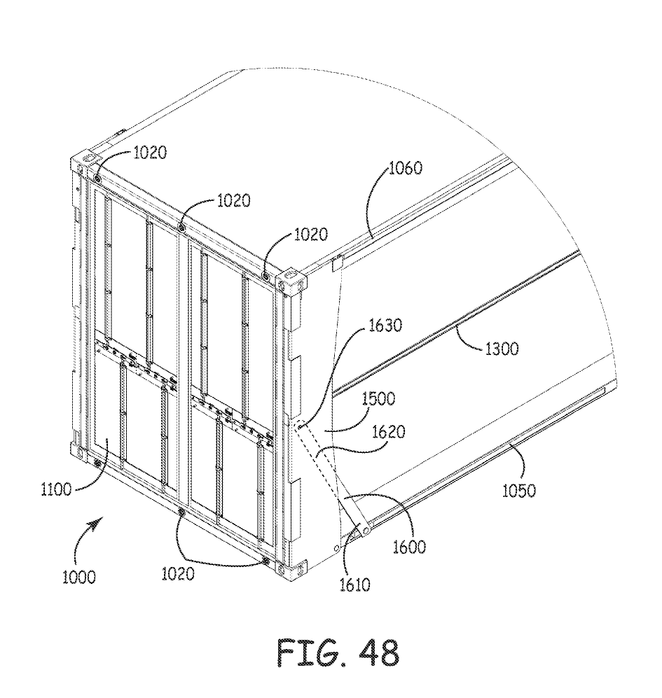

In a variety of embodiments, joint plates are replaced with other mechanisms that result in similar functionality. In the alternative embodiment depicted in FIG. 39, for example, the jointed columns 1010 each have beam flanges 1530, where each defines a beam slot 1532 (visible in FIG. 47) that are configured to receive the width of the primary lift beams 1500 when the container 1000 is fully expanded. As such, the primary lift beams 1500 provide structural support to prevent collapse of the container 1000 about the hinges of the columns 1010. Other configurations of the beam slots 1530 are also contemplated. The jointed columns 1010 can be manufactured out of a variety of materials in a variety of ways including, but not limited to: steel, aluminum, casts and composite materials.

### Cable System

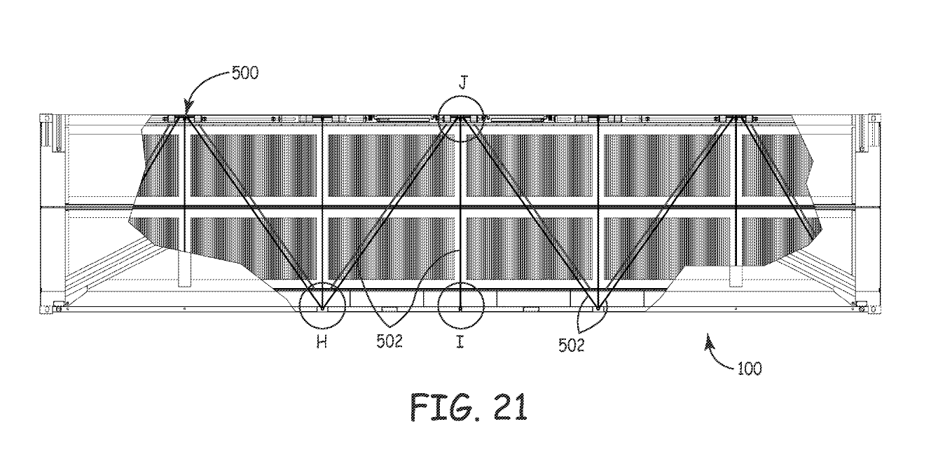

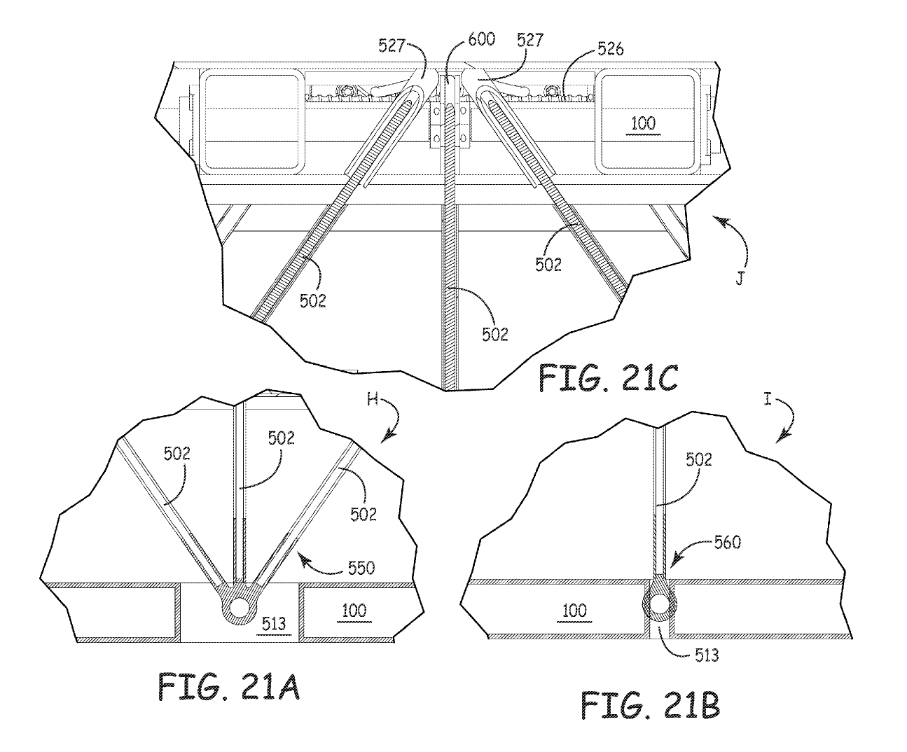

FIG. 20 is a cable system schematic as viewed from the top of the container, where FIGS. 20A-20E provide detail views of portions of FIG. 20. FIG. 21 is a cable system schematic as viewed from the side of the container, where FIGS. 21A-21E provide detail views of portions of FIG. 21. The schematics depicted in FIG. 20 and

FIG. 21 can be consistent with various embodiments of the technology disclosed herein, such as a High Cube container, a 8 feet (W) by 8.5 feet (H) by 40 feet (L) container, and so on. The cable system 500 is described below, categorized based on three functions of the cable system: providing wall tension, positioning joint plates, and lowering and raising the end wall and container door.

It will be appreciated that components described herein can have multiple functions. It will also be appreciated that the cable system can have a variety of configurations. In a variety of the implementations discussed below, spindles are incorporated with use of the cables. Such spindle systems can be an electric winch system, for example, initiated by a mechanical or electrical input, or, in another example, a mechanical system.

### Providing Wall Tension

The cable system 500 generally provides structural support of the expanded shipping container 100 through tension forces within the container walls. Individual cables incorporated into this aspect of the cable system 500 are hereinafter referred to as “tension cables” 502. The group of drives, gears, spindles, and the like, incorporated into this aspect of the cable system 500 is hereinafter referred to as the “spindle system” 520.

The spindle system 520 is configured for tightening tension cables 502 to establish tension forces within the container walls. Referring to FIG. 20, the spindle system 520 generally runs a substantial length of the container and is powered by a first spindle drive shaft 522 on a first side of the container and a second spindle drive shaft 523 on a second side of the container. Each drive shaft 522, 523 rotates about a central axis and is mechanically coupled to spindles 524 that rotate to collect (and therefore tense) or release tension cables 502 disposed thereon. Aspects of the spindle system 520 are depicted in FIGS. 20A, 20B, 20C, and 20D as well as FIGS. 21, and 21A-21C. In another embodiment (not depicted) a spindle system can be an electric winch.

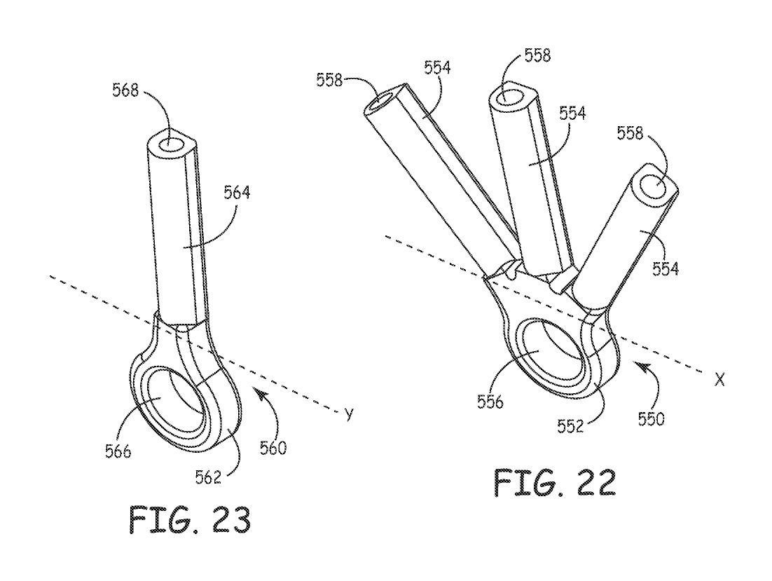

The tension cables 502 run through at least the side walls of the container 100 in vertical and diagonal orientations which is best depicted in FIG. 21 where the tension cables 502 have first ends that are fixed to the container structure, such as proximate to the bottom edge of the container 100 (or the top edge of the container 100 in some embodiments), and second ends that are fixed to a particular spindle 524. FIGS. 21A and 21B depict a cross sectional view of a triple cable connector 550 and a single cable connector 560, respectively, that are used to secure the first ends of tension cables 502 proximate to the bottom edge of the container. The triple cable connector 550 and the single cable connector 560 can be bolted, welded, positioned within an opening on the base or otherwise secured to the container. The triple cable connector 550 and the single cable connector 560 are described in more detail in the descriptions of FIGS. 22 and 23, below.

When the container 100 is expanded the spindle drive shafts 522, 523 rotate in a first direction, causing the spindles 524 to rotate such that the tension cables 502 are collected by the spindles 524 and put under tension, thereby providing support to the container walls 512. When the container is collapsed the spindle drive shafts 522 rotate in a second direction, causing the spindles 524 to rotate such that the spindles 524 release the tension cables 502 to allow for collapsing of the container 100.

As can be seen in FIG. 20C, a pathway rod 526 defining cable grooves 528 is disposed along the edge of the container 100 to accommodate the tension cables 502. The pathway rod 526 is generally associated with translating rotation from a drive shaft to portions of the cable system 500. The pathway rod 526 can be in mechanical communication with various components in the system disclosed herein, for example, components associated with positioning joint plates or lowering and raising end walls of a container, both of which are described below. FIG. 21C depicts two tension cables 502 emerging from over the pathway rod 526 through two pathway tubes 527 that each define an opening through which a tension cable 502 can pass. FIG. 21C also shows a center tension cable 502 emerging over a pulley 600.

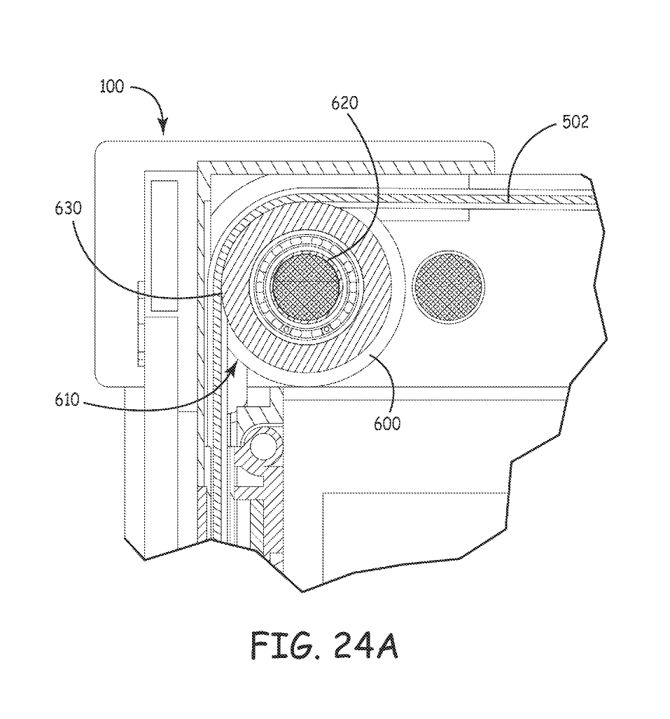

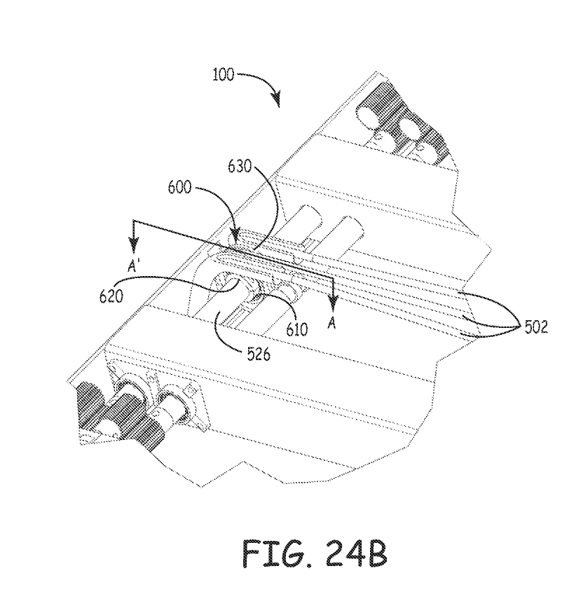

One or more pulleys could also be incorporated in the system to provide a pathway for translation of the cables from the spindle along the top of the container 100 to the container sidewall 512 that is substantially perpendicular to the top of the container 100. FIG. 21C also depicts a pulley 600 that accommodates the central tension cable 502. The pulley system can have a variety of configurations generally known in the art and be consistent with the technology disclosed herein. The pulley 600 will be described in more detail in the discussion of FIGS. 24A-24B, below.

As in visible in FIG. 20B, spindle drive shafts 523a, 523b, 523c can be mechanically coupled to the spindle 524 and each other with belts 533, 531. Rotation across the drive shafts can be transferred through chain-and-link systems, rubber pulley systems, and the like. Such configurations can provide a means to accommodate other components of the container system, or fewer components can be used.

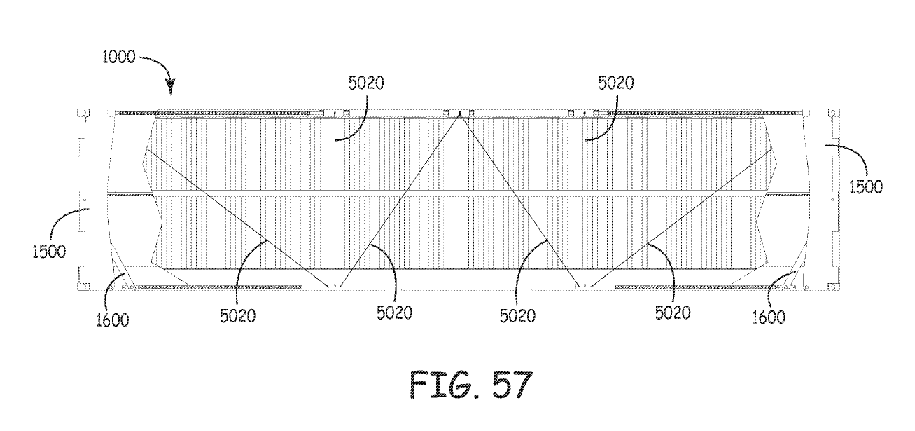

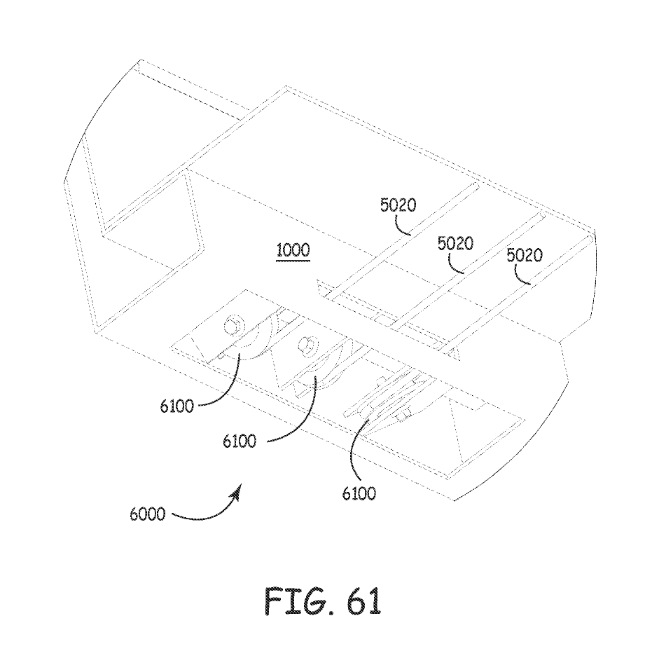

FIG. 57 depicts an alternate schematic for a cable system similar to an alternate embodiment of the technology disclosed herein. The tension cables 5020 run through at least the side walls of the container 1000 in vertical and diagonal orientations with first ends that are fixed to the container structure, such as proximate to the top edge of the container 1000, and second ends that are fixed to a particular spindle 5240 at the bottom of the container (See FIG. 60). FIG. 61 depicts a pulley system 6000 associated with the cable system similar to the alternate embodiment of the technology disclosed herein. The pulleys are at the bottom of the container and define a pathway for the cables depicted in FIG. 57 from the longitudinal side of the container to a spindle 5240 (FIG. 60) at the bottom of the container. Each pulley 6100 is oriented to receive a particular tension cable 5020 to reduce frictional forces associated with translating the tension cable 5020 from a longitudinal side of the container 1000 over the bottom edge of the container 1000 to a spindle on the bottom of the container 1000.

### Positioning Joint Plates

Secondly, the cable system 500 is configured to position joint plates as depicted and described relative to FIGS. 17-19. Individual cables incorporated into this aspect of the cable system 500 are hereinafter referred to as “position cables” 504. The group of drive shafts, gears, spindles, and the like, that are incorporated into this aspect of the cable system 500 is hereinafter referred to as the “plate gear system” 530. Aspects of the plate gear system are depicted in FIGS. 20, 20D, and 20E.

Now, referring to FIG. 20E, a plate drive shaft 532 is in mechanical communication with one or more sprockets 534 that transfer rotational motion to plate spindles 536. An end of each plate cable 504 is fixed to a first plate spindle 536a and a second plate spindle 536b where such that one spindle 536a, 536b collects the plate cable and the other spindle 536b, 536a releases the plate cable when the plate drive shaft 532. When the container 100 is expanded, the spindles 536a and 536b rotate in a manner that slides the joint plate over the container joint. When the container 100 is collapsed, the spindles 536a and 536b rotate in a direction that slides the joint plate away from the container joint (either up or down, as explained in the description of FIGS. 17-19, above). Those skilled in the art will recognize that various modifications to the design may be implemented and still remain within the scope of the technology disclosed herein.

The sprockets 534 generally transfer rotation to each other via interlocking teeth. The sprockets 534 can have a variety of shapes, sizes, and system configurations that allow the joint plates (not shown) to move a distance and direction consistent with the description herein. For example, the sprockets 534 can have a gear ratio consistent with the plate spindle 536 collecting or releasing an amount of plate cable 504 to move the joint plate a particular distance in a particular direction consistent with the description herein. The sprockets 534 can generally be constructed of any material known in the art and in one embodiment is constructed of steel, steel alloy, aluminum, or composite material.

FIG. 20E depicts pulleys 538 that are in communication with the plate spindles 536 to provide a travel pathway for plate cables 504 from a plane substantially parallel with the top of the container to a perpendicular plane substantially parallel to the length of a container column.

The sprocket drive shaft 532 is also in mechanical communication with a second sprocket drive shaft 532b that leads to the other side of the container (for example, the back of the container). The second sprocket drive shaft 532b drives a system substantially similar to the one just described for a different side of the container. Because there is no delay in the mechanical transfer of drive shaft rotation, systems operate substantially simultaneously.

### Lowering and Raising the End Wall and Container Door

Lastly, the cable system 500 is configured to lower and raise the end wall and the container door of the container 100. Individual cables incorporated into this aspect of the cable system 500 are hereinafter referred to as “end wall cables” 506. The group of drive shafts, spindles, gears, and the like, that are incorporated into this aspect of the cable system 500 is hereinafter referred to as the “end wall system” 540. Aspects of the end wall system 540 are depicted in FIGS. 20, 20D, and 20E.

An end wall drive shaft is in mechanical communication with one or more sprockets 544 that transfer rotational motion to an end wall spindle 542, where the end wall drive shaft is also the plate drive shaft 532 in the current embodiment. In at least one embodiment, the end wall drive shaft can be different and distinct from the plate drive shaft 532. A first end of the end wall cable 506 is fixed to the end wall spindle 542 such that the spindle 542 collects or releases the end wall cable 506 when the spindle 542 is rotated, and a second end of the end wall cable 506 is fixed to the top of an end wall, where the end wall can be a container door.

When the container 100 is expanded, the end wall drive shaft causes the spindle 542 to rotate in a direction that collects the end wall cable 506 to raise a container end wall and prevent collapse of the container end wall, such as when phase three of the container door locking system is engaged, as described in the discussion of FIGS. 13 and 14, above. When the container 100 is collapsed, the spindle 542 rotates in a direction that releases the end wall cable 506 to lower the container end wall. The end wall cable 506 coupled to an end wall is depicted in FIGS. 25A and 25B, and described below.

The sprockets 534 can have a variety of shapes, sizes, and system configurations that allow the end wall cable (not shown) to raise or lower a container end wall. For example, the sprockets 534 can have a gear ratio consistent with the end wall spindle 542 collecting or releasing an amount of end wall cable 506 to raise an end wall consistent with the description herein. As previously mentioned, in at least one embodiment an electric winch system can also be implemented within the system to raise or lower the container end wall.

Various components of the container 100 can define openings through which components of the cable system 500 can pass. FIGS. 20A and 20E depict such example embodiments through container support rods 511, which at least partially define the skeletal structure 104 of the container 100.

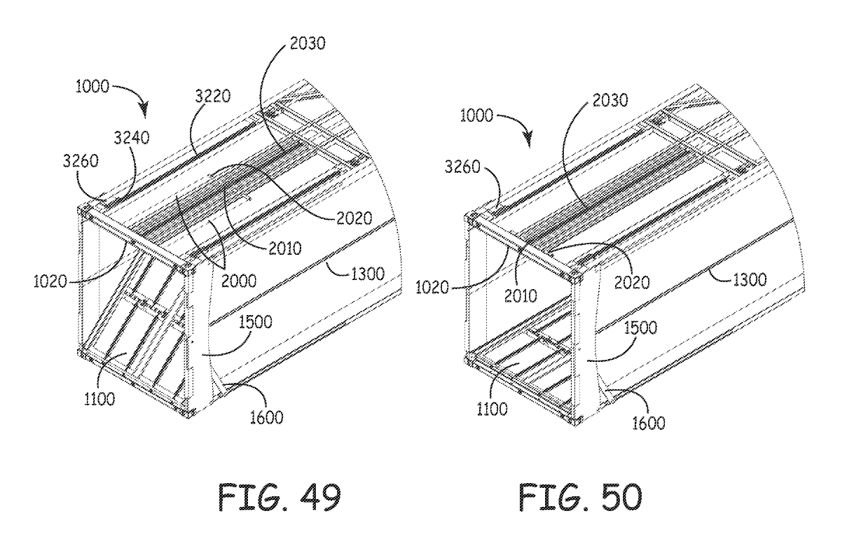

FIGS. 49 and 50 depict another approach to raising and lowering the end walls similar to the alternative embodiment of the current technology. An end wall screw 2030 is in mechanical communication with an interface 1020 for a power take-off device (PTO) and a screw receptacle 2010 similar to a screw receptacle already described herein. The screw receptacle 2010 is in communication with a first end of end wall cable 2000 and the second end of the end wall cable 2000 is coupled to the end wall 1100 through end wall apertures. As the screw receptacle 2010 progresses towards the center of the container 1000 the end wall 1100 lifts. As the screw receptacle 2010 regresses to the end of the container 1000, the end wall drops in response to gravity, to the extent allowed by the end wall cables 2000. As mentioned previously, in at least one embodiment the end wall 1100 is spring loaded to assist the end wall 1100 in collapsing when it is substantially vertical.

### Cable Connectors

FIG. 22 is a perspective view of a triple cable connector. The triple cable connector 550 has a connector ring 552 and three substantially similar, co-planar cable tubes 554 extending radially there from. The connector ring 552 is configured to couple to a container such that the cable tubes 554 extend towards the top of the container in a plane substantially parallel to a plane defined by the longitudinal side of the container. In this particular embodiment, an opening 556 is defined by the connector ring 552 and is configured to receive a bolt that secures the triple cable connector 550 to the container. The connector ring 552 can have a variety of shapes and be constructed of a variety of materials. In the current embodiment, the connector ring 552 is constructed of a composite material, steel or a steel alloy.

The cable tubes 554 are elongated tubes that extend at about 55°, 90°, and 125°, respectively, relative to a horizontal reference line x, although the cable tubes could be at a variety of other angles as well. The cable tubes 554 can have a variety of shapes and sizes, and in this embodiment are generally elongated members defining a substantially cylindrical opening 558. The elongated members of the cable tubes 554 can, likewise, be substantially cylindrical, although in the current embodiment the elongated members have at least one substantially flat surface and at least one radial surface along the length of the elongated members. The substantially flat surface of the elongated members can be configured to face the container when the connector ring 552 is attached to a container. Each opening defined by each cable tube 554 receives a cable. The end of the cable received by the cable tube 554 is forged with the cable tube 554. In one embodiment the end of the cable received by the cable tube 554 is pinched against the cable tube with a bolt, for example. Other methods could also be employed. In the current embodiment, the cable tubes 554 are constructed of steel or a steel alloy, but could also be constructed of a composite or a variety of other materials known in the art.

As depicted in FIGS. 21A, the container 100 defines a connector opening 513 that receives the triple cable connector 550 such that the connector ring 552 is placed in the connector opening 513 and the tension cable 502 secured to the cable tube 554 passes through the opening 513 at bottom of the container. The triple cable connector 550 is then coupled to the container with a bolt.

FIG. 23 is a perspective view of a single cable connection. The single cable connector 560 has a connector ring 562 and a cable tube 564 that extends upwards, radially there from. The connector ring 562 is configured to couple to a container such that the cable tube 564 extends towards the top of the container in a plane substantially parallel to a plane defined by the longitudinal side of the container. In this particular embodiment, the opening 566 defined by the connector ring 562 is configured to receive a bolt that secures the single cable connector 560 to the container. The connector ring 562 can have a variety of shapes and be constructed of a variety of materials. In the current embodiment, the connector ring 562 is constructed of steel or a steel alloy, but could also be constructed of carbon fiber or a variety of other materials known in the art.

The cable tube 564 can extend at about 90° relative to a horizontal reference line y. The cable tube 564 can be configured similarly to cable tubes associated with the triple cable connector 550 as described above. Likewise, a tension cable can be bolted within a cylindrical opening 568 of the cable tube 564. FIG. 21B depicts a cross-sectional view of a single cable connector 560 coupled to a container 100 in a connector opening 513 defined by the container 100.

### Pulley

FIG. 24A is a cross-sectional view of an example pulley system and FIG. 24B is a cut-away perspective view of the example pulley system of FIG. 24A. The pulley 600 is positioned on a pathway rod 536 and generally shares an axis of rotation with the pathway rod 536. The pulley 600 is generally a ring shape fixed over the pathway rod 536 such that the interior surface 620 of the ring is adjacent to a portion of the outer surface of the pathway rod 536. Ball bearings 610 connect the interior surface 620 of the pulley 600 and a cable surface 630 of the pulley 600, where the cable surface 630 is configured to receive a cable 502. This configuration allows a cable 502 to pass over and rotate the cable surface 630 of the pulley 600 about the axis of rotation, independently from the pathway rod 526. In some implementations of the technology disclosed herein, the pathway rod 536 may be omitted due to design variation. In such a scenario, it is possible that the pulley 600 having ball bearings 610 may still be implemented to respond to system stresses.

### Door Cables

FIG. 25A is a perspective view of a container with a front wall partially collapsed, and FIG. 25B is a perspective view of the container of FIG. 25A from a different viewing angle to depict cables 506 coupled to a container end wall, which is a container door 200.

A first end of the cables 506 are coupled to the top side of the door 200 through any means known in the art and in a variety of positions relative to the door. A second end of the cables 506 are fixed to the end wall spindles 542 that are depicted in FIG. 20D and described in the corresponding description, above. The cables 506 are configured to be collected and released by the end wall spindles 542 which raises or collapses the door relative to the container 100, respectively.

As described above, in the discussion related to raising and lowering the end walls, FIGS. 49 and 50 depict a screw receptacle 2010 in communication with a first ends of end wall cables 2000, where the second ends of the end wall cables 2000 is coupled to the end wall 1100. An electric winch system could also be implemented in one embodiment to achieve similar functionality associated with raising and lowering the end walls.

### Drive Lock

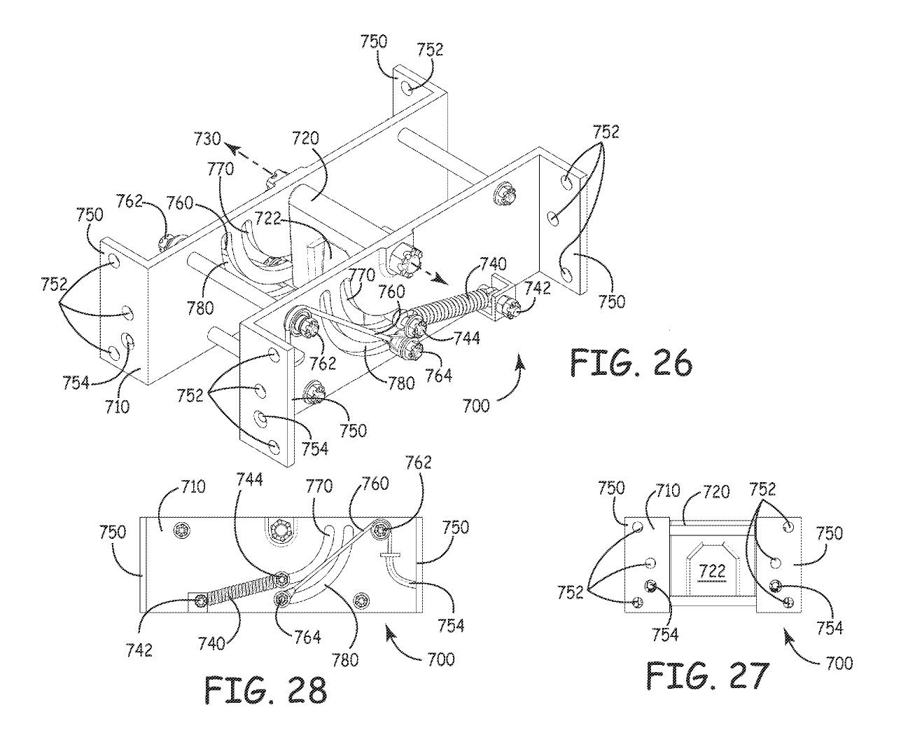

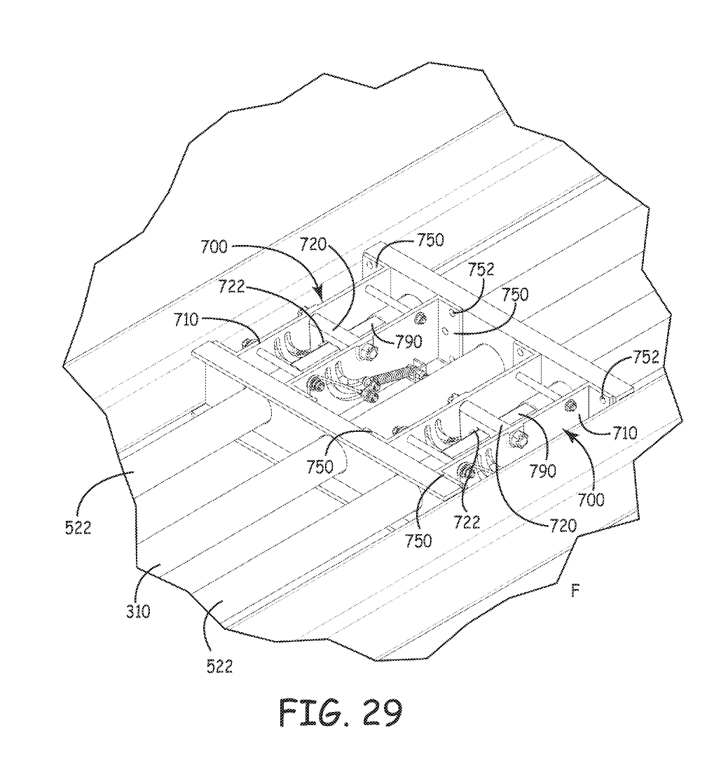

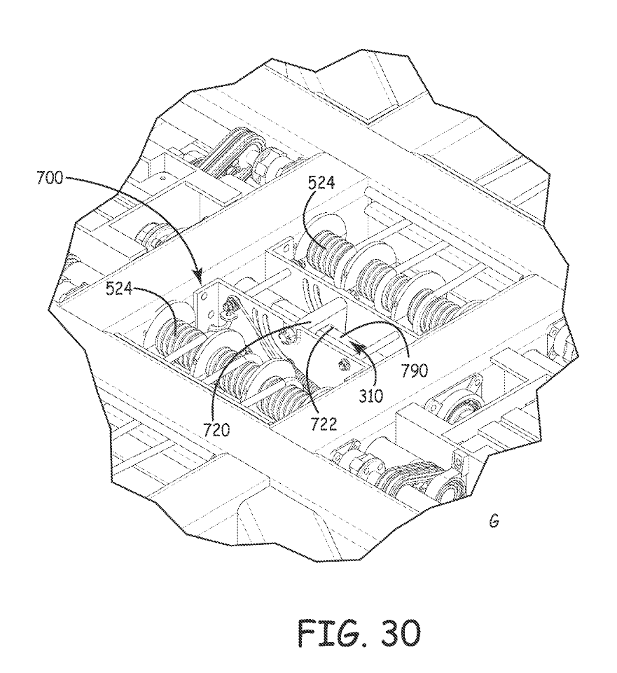

FIGS. 26-30 provide a variety of views of a drive lock for a drive shaft consistent with the technology disclosed herein. FIG. 26 is a perspective view of the drive lock 700 for the drive shaft, FIG. 27 is a front view of the drive lock for the drive shaft, and FIG. 28 is a side view of the drive lock for the drive shaft. FIG. 29 is a view of detail F in FIG. 20. FIG. 30 is a view of detail G of FIG. 20. FIG. 20 depicts four drive locks 700 in communication with the spindle system. One drive lock 700 is disposed on each of the two spindle drive shafts 522 as depicted in detail F of FIG. 20 and in FIG. 29. One drive lock 700 is disposed on each of the two spindle drive shafts 523a, as found in detail D of FIG. 20. One more drive lock 700 is disposed along the mechanical communication chain from center drive shaft 310, as found in detail G of FIG. 20 and also in FIG. 30. Other configurations may also be implemented and be within the scope of the technology disclosed herein.

FIGS. 26-28 are now described, with further descriptions of FIGS. 29-30 to follow, although viewing all the FIGS. 26-30 in light of the below description will supplement understanding of the technology herein. A drive lock 700 is generally incorporated into the container to prevent unwanted rotation of drive shafts used in the container, such as the drive shafts depicted in FIG. 20 and FIGS. 20A-20E. Rotation of the drive shafts is prevented through engagement of the drive lock 700 when the container is erect or collapsed. In other words, the drive shafts having a drive lock 700 are generally locked and unable to rotate unless the container is being either collapsed or expanded. In the current figures the drive lock 700 is substantially symmetrical, but it will be appreciated that other configurations can be implemented that would not deviate from the scope of the technology disclosed herein. Components of the drive lock 700 can comprise a variety of materials. In one embodiment the drive lock 700 comprises a metal. In such an embodiment the drive lock could be constructed of a steel or steel alloy, aluminum, composite material, or the like.

The drive lock 700 has a lock plate 720 defining an opening 722 that is pivotably disposed on a drive lock body 710 at a pivot axis 730. The plate opening 722 is configured to receive, and prevent rotation of, a drive shaft. In the current embodiment best viewed in FIG. 29, the lock plate 720 defines a partial octagonal plate opening 722. In such an embodiment the portion (790 in FIGS. 29 and 30) of the drive shaft corresponding to the lock plate 720 has an octagonal shape so that the mating shapes between the lock plate 720 and the drive shaft prevent the drive shaft from rotating. The plate opening 722 and the portion of the drive shaft configured to be received by the lock plate 720 can have a variety of different mating shapes and profiles without deviating from the scope of the technology disclosed herein.

The drive lock body 710 is configured to be coupled to at least a portion of the container and to provide pivot points and support for the lock plate 720. In the current embodiment the drive lock body 710 has flanges 750 that define openings 752 through which the drive lock body 710 can be coupled to a container, which will be described in more detail in the description of FIGS. 29 and 30, below. The flange also defines a cable run 754 through which a lock plate cable 760 passes.

The lock plate cable 760 causes disengagement of the drive lock 700 from the respective drive shaft mating shape 790, and runs from a user-interface on the container, through the cable run 754, over a lock plate pulley 762, and is coupled to a cable anchor 764. The cable anchor 764 is mechanically coupled to the lock plate 720 through a release pathway 780 defined by the drive lock body 710, such that pulling the lock plate cable 760 causes the cable anchor 764 to travel along the release pathway 780 defined by the drive lock body 710, thereby pivoting the lock plate 720 to a non-vertical disengaged position.

A first end of a locking spring 740 is coupled to a spring anchor 742 that is disposed on the drive lock body 710. A second end of the locking spring 740 is coupled to a spring bolt 744, where the spring bolt 744 is mechanically coupled to the lock plate 720 through an engagement pathway 770 defined by the drive lock body 710. The forces exerted by the locking spring 740 prevents the lock plate 720 from pivoting, and thereby keeps the drive lock 700 engaged, or, in other words, keeps the lock plate 720 in a substantially vertical state by which the lock plate 720 engages the drive shaft. So, unless the force exerted by the spring 740 to prevent the lock plate 720 from pivoting is overcome by the force of the lock plate cable 760 to pivot the lock plate 720, the drive lock 700 remains engaged.

The release pathway 780 defined by the drive lock body 710 is configured to accommodate the cable anchor 764 along the path of travel of the cable anchor 764 as the lock plate 720 pivots. Likewise, the engagement pathway 770 defined by the drive lock body 710 is configured to accommodate the spring bolt 744 along the path of travel of the spring bolt 744 as the lock plate 720 pivots.

As mentioned above, FIG. 29 and FIG. 30 are detail views of FIG. 20, depicting portions of the top of the container that incorporate one or more drive locks. FIG. 29 depicts the drive locks 700 disposed in mechanical communication with the spindle drive shafts 522 described above. FIG. 30 depicts a drive lock 700 disposed in mechanical communication with a screw system drive shaft 310 as described above. In both FIGS. 29 and 30 the drive shafts have a hexagonal cylindrical portion 790 that is received by the plate opening defined by the lock plate 720.

### Slip Gear System

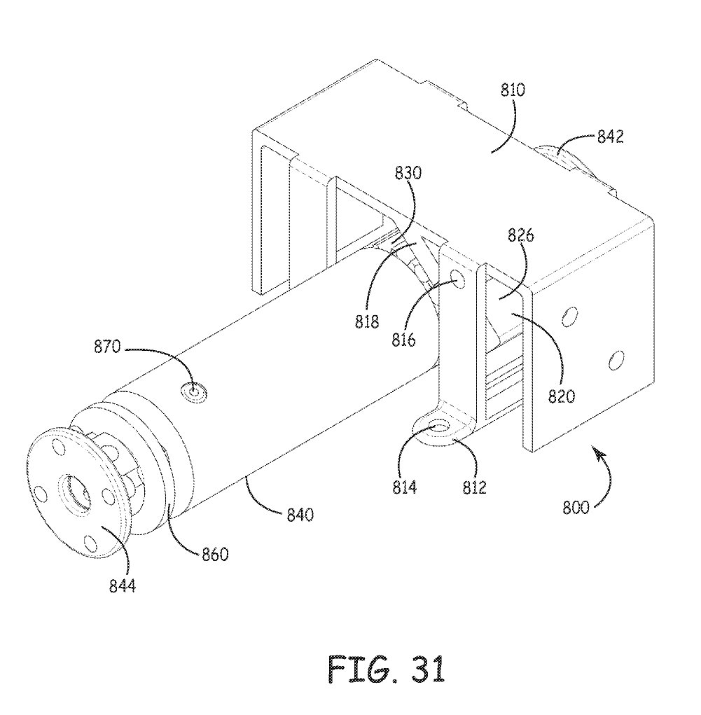

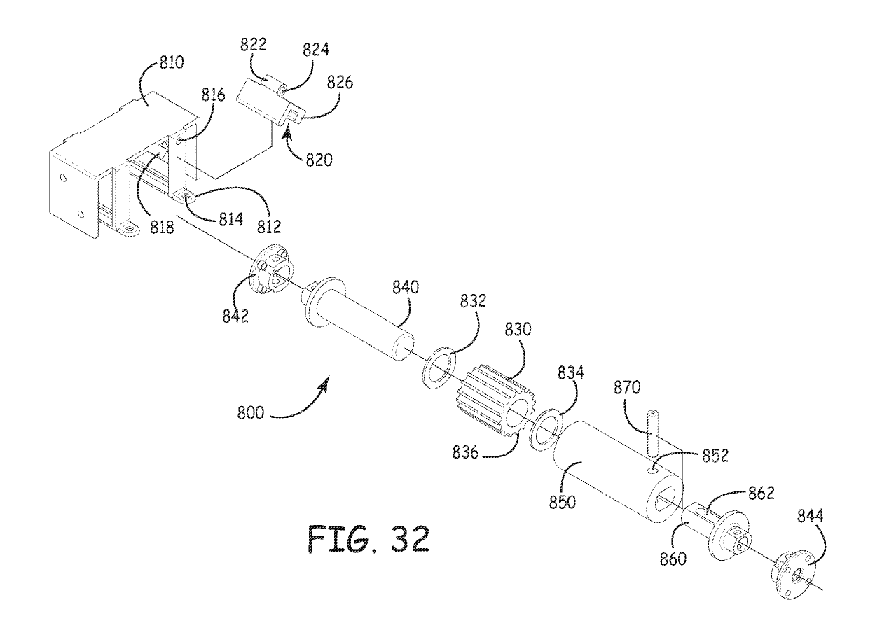

FIG. 31 is a perspective view of a slip gear system, and FIG. 32 is an exploded view of the slip gear system depicted in FIG. 32. The slip gear system 800 is generally configured to prevent rotation of particular components in particular directions and, as visible in FIG. 20A and 20D, is in mechanical communication with the screw system drive shaft 310 in at least one embodiment. The slip gear system 800 is configured to prevent the container from unintentionally collapsing if there is a mechanical failure when the container is in an upright position or being expanded. The slip gear system can also be used in conjunction with other components as a primary or secondary locking device, such as drive shafts and spindles.

The slip gear system 800 has a gear housing 810 that is configured to couple to a container with openings 814 defined by coupling flanges 812. A gear shaft 840 is received by an opening defined by the housing 810 and the gear shaft 840 receives a first clutch washer 832, a locking gear 830, a second clutch washer 834, and a pinion barrel 850, where such components are rotatably disposed on the gear shaft 840. The gear shaft 840 is coupled to a drive shaft, for example, with a first clutch adapter 842 coupled to one end of the gear shaft 840. The pinion barrel 850 defines an opening that receives a slide clutch 860, where a pin opening 852 defined by the pinion barrel 850 and a pin pathway 862 defined by the slide clutch 860 mutually receive a pin 870. The slide clutch is likewise configured to couple to a drive gear with a second clutch adapter 844 disposed thereon.

A sway lock 820 is coupled to the housing 810 with a hinge 822, where a coupling mechanism such as a pin mutually passes through a sway lock opening 816 defined by the housing 810 and the hinge opening 824 defined by the hinge 822 of the sway lock 820. The sway lock 820 is disposed within a cavity defined by the housing so as to be in mechanical communication with a locking gear 830. The housing 810 further defines a lock stop 818 that is generally a flange extending downwardly at an angle consistent with preventing rotation of the sway lock 820 beyond a particular angle.

The slip gear system is generally configured to ratchet as a container is expanded. In various embodiments the slip gear system 800 provides auditory indication that the container is in the process of being expanded. For example, in the current embodiment teeth 834 defined by the locking gear 830 make contact with the sway lock 820, causing the sway lock 820 to pivot up slightly about its hinge 822. After a tooth 834 passes, gravity causes the sway lock 820 to pivot back down again, providing an auditory alert of the expansion process. A counterweight 826 can be included on the sway lock 820 to enhance such functioning. When the container is collapsed, pressure is relieved from the locking gear 830, which allows the drive shaft to rotate in the opposite direction.

### Power Take Off Device

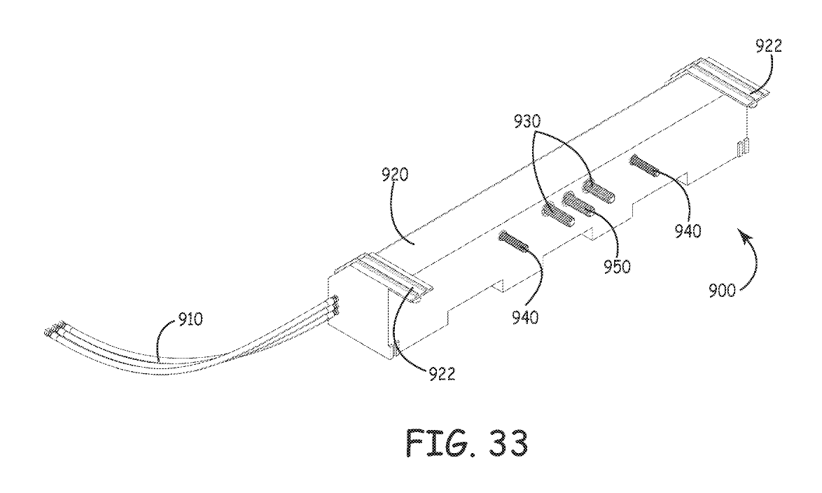

FIG. 33 depicts an example power take-off unit, which will be referred to as a PTO for purposes of this application. The PTO 900 generally initiates and sustains rotation of the various container drive shafts of the container system for collapsing and expanding the container. The PTO 900 is generally powered with hydraulic fluid or, in some embodiments, electrical current through an electrical connection 910 and is coupled to PTO drive inserts 120 on one side of the container, such as those visible on FIG. 1. From the view in FIG. 1 five PTO drive inserts 120 are visible. Although other driving mechanisms can be used, a PTO 900 is contemplated with at least a single interface incorporated in the container that couples the PTO to a gear system. Forklift tine sleeve 924 are defined by the PTO housing 920 that are configured to accommodate the tines of a forklift. The PTO in the current figures has four forklift tine sleeves 924, so that it can accommodate either a large or small forklift. A large forklift could use the two outer forklift tine sleeves 924 while a small forklift would use the two inner forklift tine sleeves 924. In some embodiments only two forklift tine sleeves would be appropriate.

The PTO 900 has a PTO housing 920 that can be configured to accommodate the shape of a container and, in some embodiments, couple to the container. Two coupling surfaces 922 extend from the top of the PTO 900 where the coupling surfaces 922 are configured to engage the top of the container during the collapsing or expanding process. Each coupling surface 922 is the bottom surface of a flange that is configured to extend substantially parallel to the top surface of the container when the PTO is mounted to a container, and in some embodiments, engage the top of the container. It will be appreciated by those skilled in the art that the PTO housing can engage connecting points of the container, where the connecting points of the container are the standard points at which containers mutually engage when they are stacked (and are generally known in the art). The coupling surfaces 922 could define a mating component that mates with a corresponding mating component on the container, in some example embodiments. In another example, the coupling surfaces 922 can define openings corresponding to openings on the container through which a lock or a pin can be passed. Those skilled in the art will appreciate a variety of different approaches to mounting the PTO to a container.

Protrusions 930, 940, 950 extending from the PTO are configured to be received by drive inserts defined by the container and mentioned above. Plate drives 940 are configured to be in communication with the plate drive shaft 532 described in the description of FIGS. 20-21C. Tension drives 930 are configured to be in communication with the spindle drive shaft 522 described in the description of FIGS. 20-21C, above. Screw system drive 950 is configured to be in communication with the screw system drive shaft 310 as described in the description of FIG. 16, above. A user interface on the PTO 900 can allow a user to choose which way the PTO drives should rotate, correlating to either expanding or collapsing of the container. In another embodiment a computer could interface with the PTO drives. In such an embodiment a user can provide instruction to the PTO through a user interface on the computer.

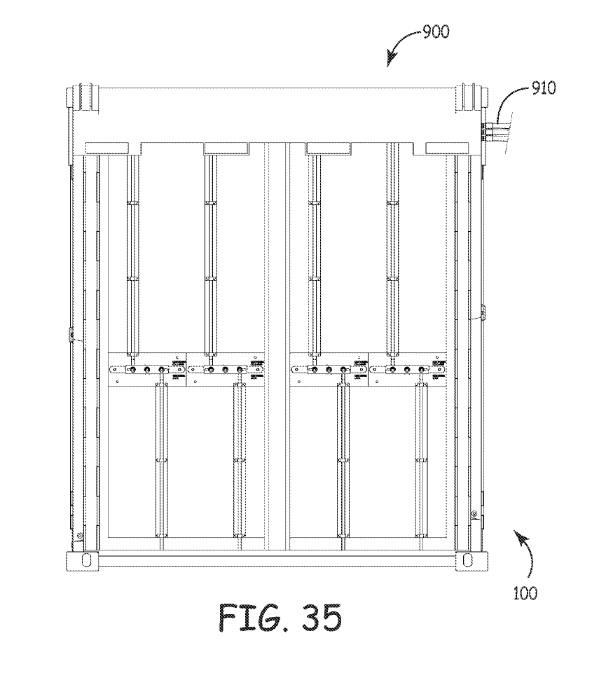

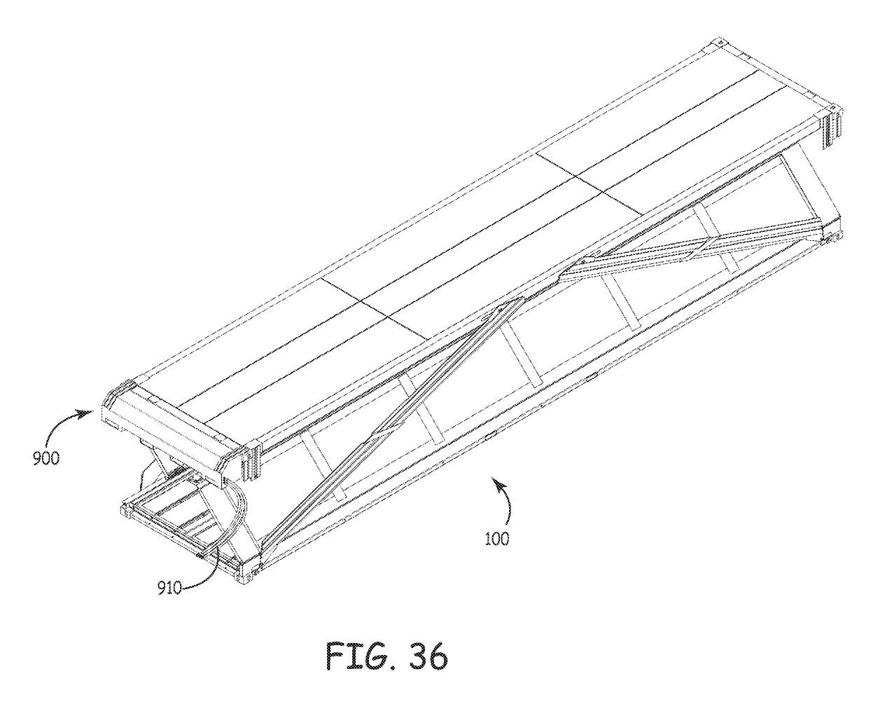

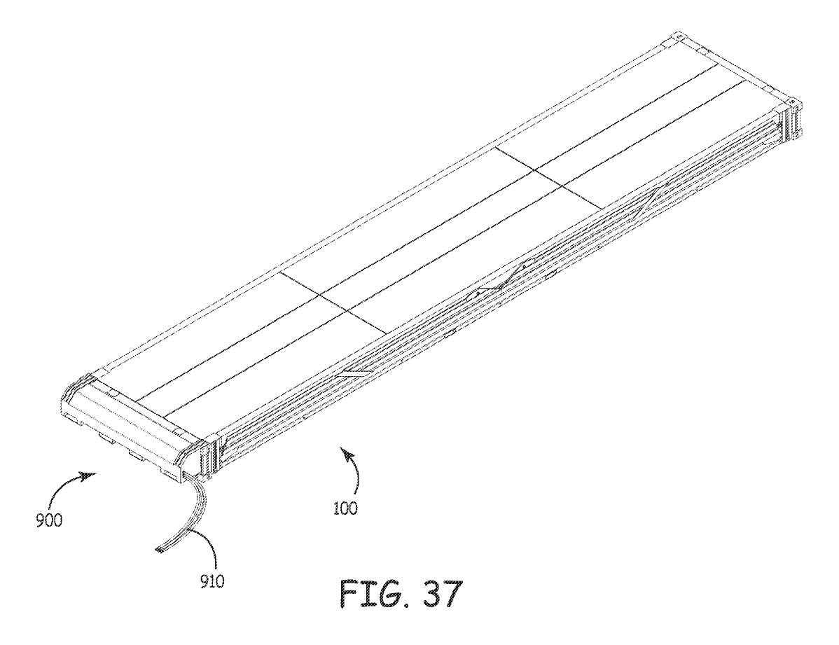

FIG. 34 is a perspective view of the example PTO of FIG. 33 connected to the container. FIG. 35 is a front view of the example PTO of FIG. 33 connected to the container. FIG. 36 depicts the example PTO of the FIG. 34 connected to the container where the PTO is starting to collapse the container. FIG. 37 depicts the example PTO of FIG. 34 connected to the container where the PTO has collapsed the container.

When the container 100 is collapsed, the drives of the PTO 900 are aligned and inserted in the PTO drive inserts of the container 100. The PTO 900 is powered on and the drives transfer rotational motion to the various drive shafts of the container 100 that cause the container to collapse. The container then collapses consistent with the disclosure herein. The PTO 900 can then be powered off.

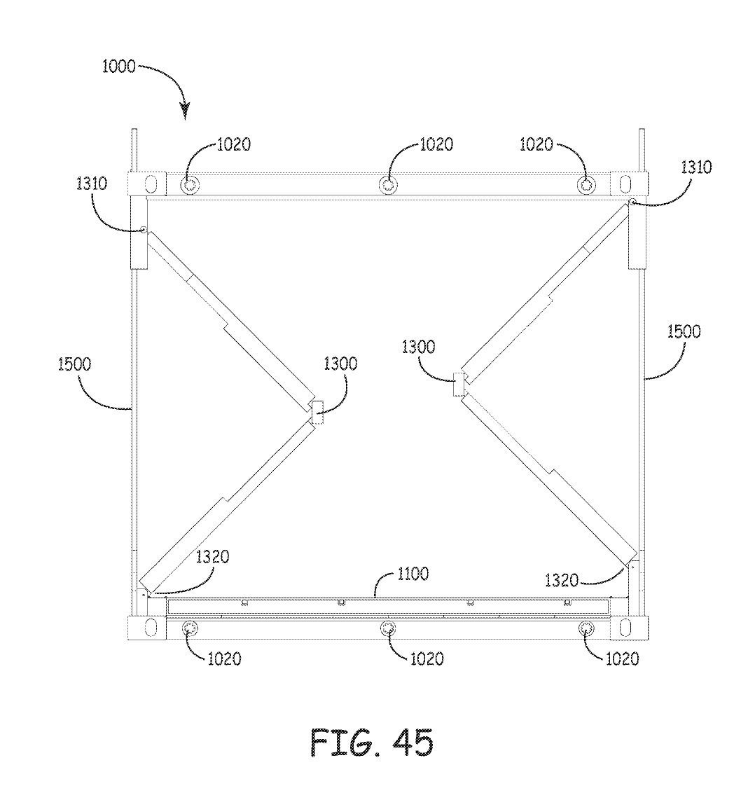

The alternate embodiment of the shipping container depicted in FIG. 39 (and more easily viewable in FIG. 45) has PTO coupling surfaces 1020 on both the top and bottom of the container 1000 to accommodate screws, drives, and the like, on both the top and bottom of the shipping container.

It will be appreciated that other devices may be used instead of, or in conjunction with a PTO, such as an electrical auxiliary device to be used with, for example, an electric winch.

### Container Stacking

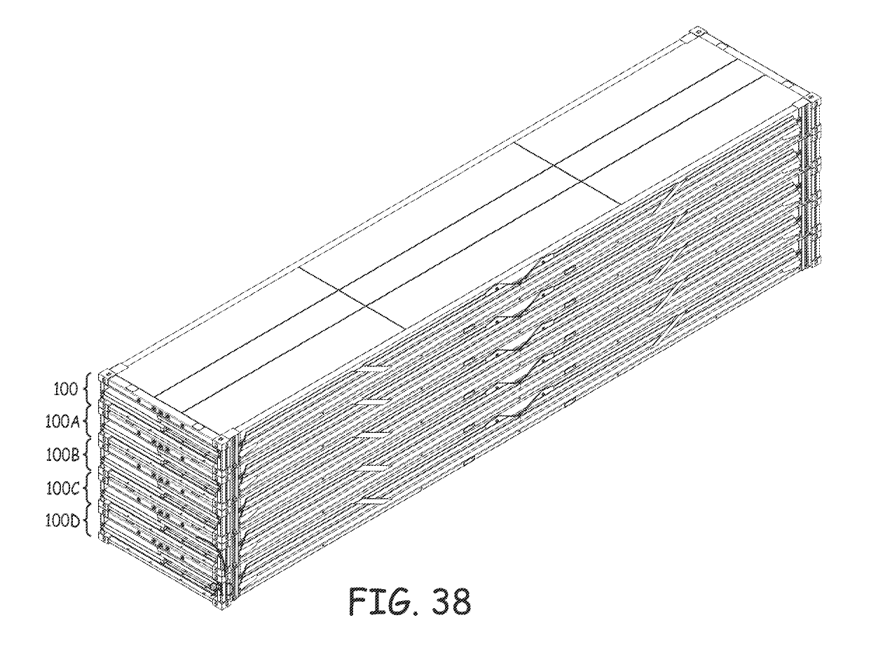

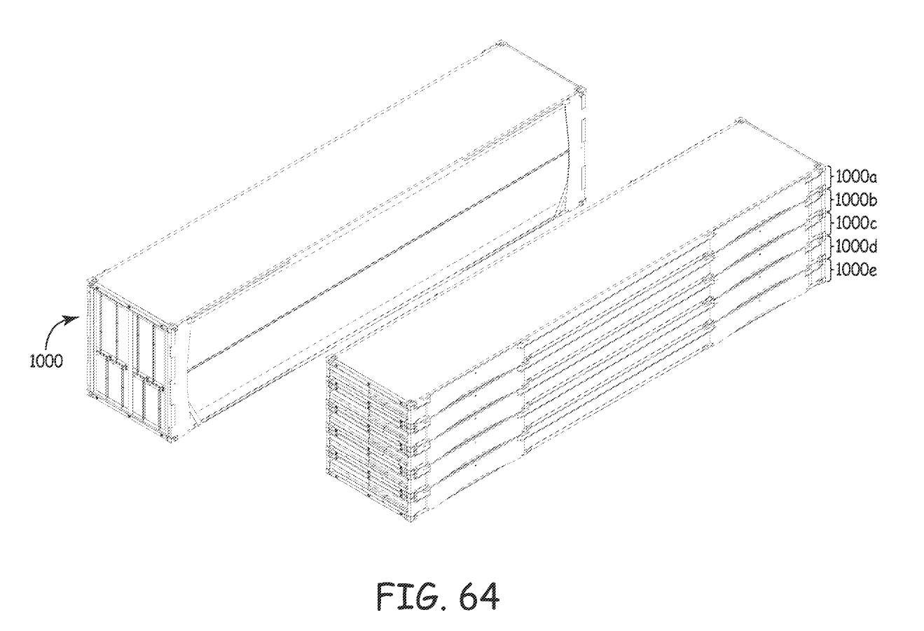

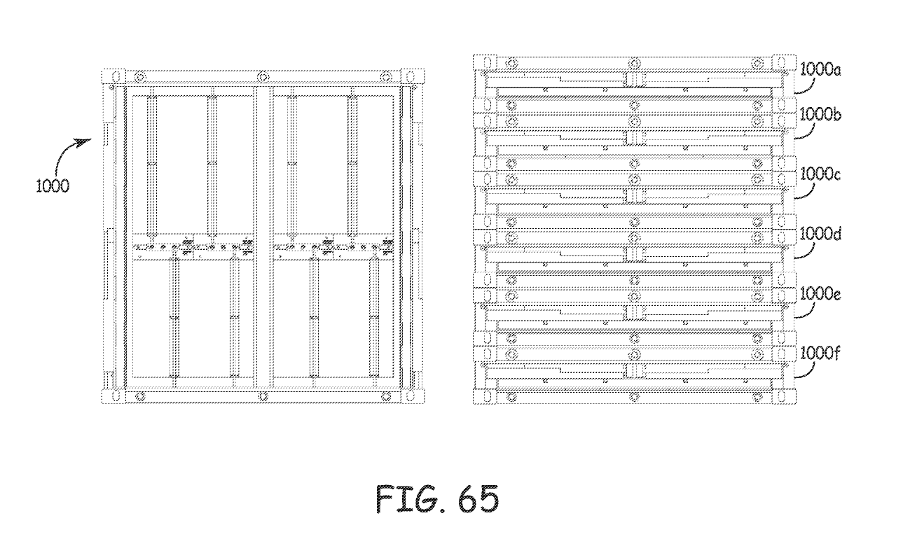

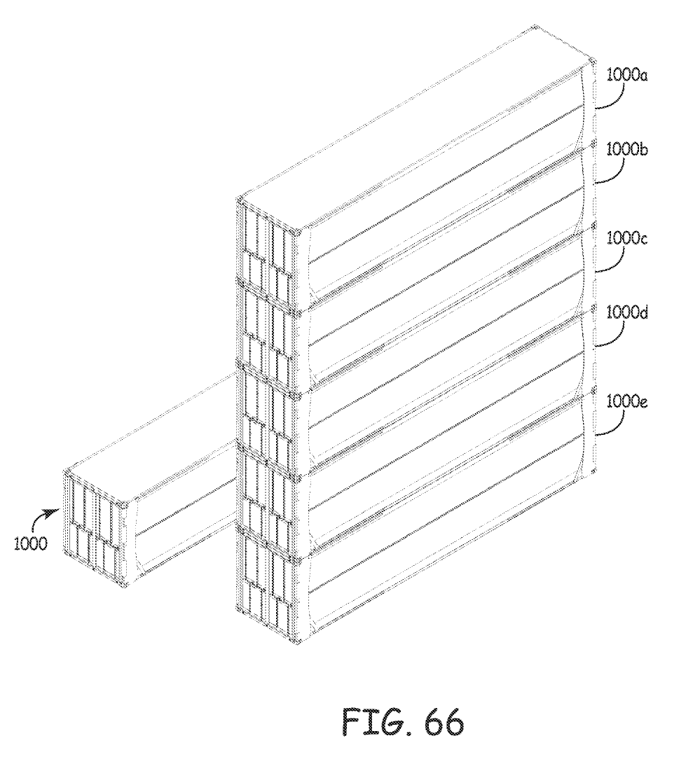

FIG. 38 depicts a stack of collapsed containers consistent with the technology disclosed herein. A first container 100 is stacked on a second container 100A, which is stacked on a third container 100B, which is stacked on a fourth container 100C, which is stacked on a fifth container 100D. FIGS. 64-66 depict a container consistent with an alternative embodiment of the technology disclosed herein compared to stacked containers of a similar structure, where FIGS. 64 and 65 provide a perspective view and a front view, respectively, of collapsed and stacked shipping containers, and FIG. 66 depicts a perspective view of expanded and stacked shipping containers.

Many mechanisms are known for securing containers to each other in stacked configurations and any of these mechanisms, and others, can be used to secure the collapsed containers to each other in a stack. An example mechanism is a corner connector component that is manufactured for Sea Box shipping containers in Riverton, N.J.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive.

1-9. (canceled)

10. A shipping container with a tensioning mechanism comprising:
a shipping container having a sidewall and an edge, where the sidewall defines passages through which cable can pass;
a plurality of tension cables running through the passages in a plane substantially parallel to a plane defined by a surface of the sidewall, where each cable of the plurality of tension cables has a first end coupled proximate to the edge of the container and a second end;
a spindle system connected to the second ends of the tension cables and configured to collect the one or more tension cables when the container is expanded and release one or more tension cables from the second ends when the container is collapsed.

11. The tensioning mechanism of claim 10 wherein the cables are synthetic cables.

12. The tensioning mechanism of claim 10 wherein the cables are steel cables.

13. The tensioning mechanism of claim 10 further comprising a pulley system defining a translation pathway for each tension cable from a substantially vertical plane to a substantially horizontal plane.

14. A tensioning mechanism for a shipping container comprising:
a first cable having a first end and second end, where the first end of the first cable is fixed adjacent to a first edge of a wall;
a second cable having a first end and second end, where the first end of the second cable is fixed proximate to the first edge of the wall;
a spindle fixed proximate to a second edge of the wall where the spindle is configured to collect and release the first cable from the second end of the first cable and the second cable from the second end of the second cable;
a spindle drive in communication with the spindle.

15. The tensioning mechanism of claim 14 wherein the cables are synthetic cables.

16. The tensioning mechanism of claim 14 wherein the cables are steel cables.

17. The tensioning mechanism of claim 14 further comprising a pulley system defining a translation pathway for each tension cable from a substantially vertical plane to a substantially horizontal plane.

18. A tensioning mechanism for a shipping container comprising:
a plurality of cables fixed proximate to a first edge of a container;
a spindle system configured to collect one or more tension cables from a second edge of the container when the container is expanded and release one or more tension cables from the second ends when the container is collapsed.

19. The tensioning mechanism of claim 18 further comprising a pulley system defining a translation pathway for each tension cable.

20. The tensioning mechanism of claim 19 wherein the pulley system defines a translation pathway from a substantially vertical plane to a substantially horizontal plane.

21. The tensioning mechanism of claim 18 wherein the spindle system is in communication with a drive shaft.

22. The tensioning mechanism of claim 21 wherein the spindle system is in communication with a power take-off device insert.

23-39. (canceled)

40. A locking system comprising:
a door of a structure;
a door frame coupled to the first door and pivotably coupled to the structure;
a lock handle pivotably disposed on a door, configured to have a first position in a first phase of a locking system;
the lock handle configured to have a second position in a second phase of a locking system;
the lock handle configured to have a third position in a third phase of a locking system.

41-42. (canceled)

43. The locking system of claim 40 wherein the second position is at a first angle relative to the first position.

44. (canceled)

45. The locking system of claim 40 wherein the third position is at a second angle relative to the first position.

46. (canceled)

47. The locking system of claim 40 wherein in the first phase the door is secured to the door frame and the structure and the door frame is secured to the structure.

48. The locking system of claim 40 wherein in the second phase the door is secured to the door frame.

49. The locking system of claim 40 wherein in the third phase the doorframe is secured to the structure.

50. The locking system of claim 40 further comprising an upper lock rod and a lower lock rod in mechanical communication with the lock handle, the door frame, and the structure.
